(19) United States
(12) Patent Application Publication
(10) Pub. No.: US 2024/0171028 A1
(43) Pub. Date: May 23, 2024

(54) ROTATING ELECTROMECHANICAL APPARATUS AND METHOD OF MANUFACTURE OF STATOR WINDING

(71) Applicant: CHE-MOTOR AG, Baden (CH)

(72) Inventor: Walter Haller, Wettswil (CH)

(73) Assignee: CHE-MOTOR AG, Baden (CH)

(21) Appl. No.: 18/282,816

(22) PCT Filed: Mar. 18, 2022
(86) PCT No.: PCT/EP2022/057161

§ 371 Date: Sep. 19, 2023

(30) Foreign Application Priority Data
Mar. 19, 2021 (WO) PCT/EP2021/057125

(51) Int. Cl. H02K 3/47; H02K 15/06

(52) U.S. Cl. CPC H02K 3/47; H02K 15/061

(57) ABSTRACT

The present disclosure relates to a rotating electromechanical apparatus including a ring-cylindrical ironless stator arranged adjacent to the inner surface or outer surface of a casing, respectively, which stator includes a continuous hairpin winding having two layers; a method for manufacturing the continuous hairpin winding comprising folding-over a ribbon of a plurality of wires successively to form a flattened helical ribbon, bending, into each wire of the flattened helical ribbon a straight segment, thereby forming a flattened quasi-helical ribbon, and rolling the flattened quasi-helical ribbon into a cylindrical shape to form a cylindrical continuous hairpin winding, with the straight segments running substantially parallel to a cylinder axis of the cylindrical shape; and a folding apparatus for manufacturing the continuous hairpin winding.

### CROSS-REFERENCE TO RELATED APPLICATIONS

This application is a U.S. National Stage Application that claims the benefit of the filing date of International PCT Application No. PCT/EP2022/057161, filed on Mar. 18, 2022, that in turn claims priority to International PCT Application No. PCT/EP2021/057125, filed on Mar. 19, 2021, that are hereby incorporated by reference in their entirety.

### TECHNICAL FIELD

The present disclosure relates to a rotating electromechanical apparatus, a method of manufacture of a stator winding, and a folding apparatus for manufacturing a stator winding. The present disclosure also relates to a stator winding obtained by the method for manufacture of the stator winding.

### BACKGROUND

Rotating electromechanical apparatuses, such as electric motors and electric generators, are well known and used in many domestic, industrial and automotive applications and are available in many sizes and types, depending on their intended use. In many electromechanical apparatuses, an alternating current applied to an electrical winding of a stator generates a rotating electromagnetic field, which induces a torque in a rotor, the rotor having, for example, a set of permanent magnets which interact with the rotating electromagnetic field, rotor coils or rotor windings, rotor conductors through which an induced current generates an electromagnetic field, or soft magnetic materials in which non-permanent magnetic poles of the rotor are induced.

Electric motors or generators typically have a stator which has a stator iron and a stator winding, the stator winding being arranged inside slots of the stator iron. The stator iron is typically a stack of laminated sheets of a magnetic alloy material which acts as a medium to direct the magnetic flux and as a structural support for the stator winding. The stator winding comprises conductors in many forms, such as Litz wires, which are wound inside the stator in the slots of the stator iron, or single hairpin wire segments, which are inserted into the slots of the stator iron and then electrically joined together, for example by using laser welding.

Ironless motors, however, have no material of high magnetic permeability inside or extending into a region of the windings.

Ironless motors typically have simple windings of coils, such as disclosed in DE 3401776A1 and DE 4414527 C1. Further prior art such as DE 102011111352A1, U.S. Pat. Nos. 4,924,125A, and 4,211,452A show windings comprising straight conductive segments parallel to a rotation axis mechanically joined to one another by electrical connection elements.

DE 102005051059A1 discloses an electric motor with an ironless winding formed of a plurality of single wire coils, wherein the single coils overlap one another in the manner of roof tiles.

US 2013/0300241 A1 discloses a cylindrical ironless stator coil comprising a plurality of wires wrapped around a ring-cylindrical bobbin at a tilt angle to an axis of rotation.

WO 2008/119120 A1 discloses a wave winding arrangement and a method of manufacture thereof.

US 2013/0241369 A1 discloses an automotive rotary electric machine and a winding assembly manufacturing method.

EP 1 469 579 A1 discloses an electric rotating machine and, more particularly, a stator included in the electric rotating machine, such as a generator for vehicles.

### SUMMARY

It is an object of embodiments disclosed herein to provide a rotating electromechanical apparatus, a method of manufacture of a stator winding for such a rotating electromechanical apparatus, and a folding apparatus for manufacturing such a stator winding which overcome one or more of the disadvantages of the prior art.

In particular, it is an object of embodiments disclosed herein to provide a rotating electromechanical apparatus, e.g. electric motor or generator, with improved electrical efficiency compared to those known from prior art. Further, a method of manufacture of a stator winding for such a rotating electromechanical apparatus is disclosed which allows for faster and more reliable manufacture of a stator winding. Further, the method of manufacture allows for the windings to be manufactured in a simplified manner and at lower cost. These objectives are achieved by the subject-matter of the independent claims. In addition, further advantageous embodiments follow from the dependent claims, claim combinations and from the description and figures. Therein, various embodiments can in general be combined with one another, except when being exclusive alternatives.

The present disclosure relates to a rotating electromechanical apparatus comprising a casing having a substantially cylindrical inner surface and/or outer surface, depending on whether the apparatus has an internal rotor or an external rotor. The term substantially cylindrical includes cylindrical mantle shapes with or without deviations from cylindrical. A ring-cylindrical ironless stator is arranged adjacent to the substantially cylindrical inner surface, in case of an internal rotor, or to the substantially cylindrical outer surface, in case of an external rotor, of the casing, respectively, the stator including a continuous hairpin winding having at least two layers, in particular exactly two layers or a multiple of two layers. The casing functions as a support structure for the ring-cylindrical ironless stator. The rotor is arranged coaxially with the ironless stator, either inside the stator in the case of an internal rotor, or outside the stator, in the case of an external rotor.

The apparatus includes the fixedly arranged stator and the rotatable rotor. The rotating electromechanical apparatus is, for example, an electric motor or an electric generator. In particular, the apparatus is a ring-shaped electric motor or ring-shaped electric generator, and/or in particular is a radial flux electric motor or a radial flux electric generator. Depending on whether the stator is arranged on the inside of the casing or the outside of the casing, the casing has a substantially cylindrical inner surface or outer surface, or both. The cylindrical inner and/or outer surface of the casing is or are substantially cylindrical without significant protrusions. In particular, the inner and/or outer surface of the casing does not have any slots configured to receive the continuous hairpin winding. As the casing does not extend into a region of the stator, in particular not into a region of the continuous hairpin winding, the stator is commonly referred to as an ironless stator, which has no material of high magnetic permeability inside or extending into a region of the winding.

An advantage of having an ironless stator is that the electromechanical apparatus has a higher electric efficiency and requires less space in radial dimension, in particular can be manufactured in ring-cylindrical shapes of reduced radial dimension. Further, the electromechanical apparatus with the ironless stator does not have a pronounced cogging effect. However, to date, ironless motors have typically been applied only or mainly to electric motors of small sizes and power. Due to a lack of high performance stator and/or rotor windings, ironless motors have so far not been widely used in electric high power applications, such as in industrial or automotive applications.

The continuous hairpin winding of the invention comprises wires which are hairpin-shaped and provide straight wire segments which run in parallel to a cylinder axis of the continuous hairpin winding, the cylinder axis being coaxial with a rotational axis of the rotor. Next to a first straight segment, on one or both ends of the straight segment, the wire is folded and bent such that a subsequent second straight segment runs anti-parallel at a distance to the first straight segment. The hairpin winding is continuous in that each hairpin wire section, defined by comprising one or two or few straight segments, is continuous with the next hairpin wire section. In particular, there is no necessity for electrical joins created by welding, soldering, or similar technique between the hairpin wire sections. However, the wires of the continuous hairpin winding may ultimately be joined by some welding or similar technique at their ends, e.g. for star-grounding or delta-connecting different phases of the continuous hairpin winding, as explained below in more detail. The continuous hairpin winding has two layers of hairpin wire one upon the other when seen in a radial direction. A given wire changes position, for example, from a first layer to a second layer or vice versa when seen around the continuous stator winding such that the first straight segment is arranged in the first layer and then is folded and bent such that the second or subsequent or next straight segment is arranged in the second layer.

In an embodiment, the casing has a substantially cylindrical inner surface or cylindrical mantle surface, and the stator is arranged inside the casing adjacent to the cylindrical inner surface of the casing. In this embodiment the rotor is an internal rotor.

In an embodiment, the internal rotor is itself a ring-cylindrical rotor, such that the electromechanical apparatus partially encloses a cylindrically shaped empty region. This allows to build e.g. ring-shaped motors for specific applications.

In an embodiment, the continuous hairpin winding consists of one or more substantially rectangular or flattened wires which are insulated. Preferably, the wires have an aspect ratio of width to height in a range of 1:1-5:1. More preferably, the aspect ratio is 2:1. The particular aspect ratio chosen depends on the application of the apparatus. The wires are either drawn or rolled. The wires have a conducting core preferably made of copper and an insulating layer on the outside. Further, the geometry of the corner radius of the wire will also depend on the application, in particular on the design of an insulating layer on the outside of the wire.

In an embodiment, the wires are comprised of a plurality of round conductors, in particular litz wires, each wrapped in a conductor insulator to form a conductor package, in particular the conductor package being wrapped in an outer insulator.

In an embodiment, the plurality of round conductors are arranged relative to one another in a flat shape, in particular parallelogram-like shape, thereby forming the rectangular or flattened wire.

In an embodiment, the continuous hairpin winding can comprise a plurality of interlaced phase windings, each phase winding consisting of one or more adjacent wires, preferably comprising one to five adjacent wires, more preferably comprising one or three adjacent wires. Preferably, three phase windings are used in which each phase is driven by an alternating power source, each phase winding being driven by current shifted by a phase angle of 120° with respect to the other phase windings. The number of wires, which each phase winding has, depends on the application, in particular, it depends on the number of induced electromagnetic poles the stator is configured for and the aspect ratio of the wires used. Fewer wires increase a fill factor of conductor in the ironless stator. The wires of each phase winding may be electrically joined together only at an area, where input leads are arranged, for example to electrically join all wires of a given phase winding together. The wires of each phase winding may also be electrically joined to form a star-ground (also known as a star connection), or a delta connection.

In an alternative embodiment, the continuous hairpin winding can comprise a plurality of interlaced phase windings, each phase winding consisting of a single uninterrupted wire having multiple turns around the stator, preferably three turns or five turns. In this embodiment even fewer, or even no electrical joins, e.g. by welding or similar, can be required, because each phase winding can consist of only a single uninterrupted wire. The number of turns refers to the number of times a given hairpin wire circumnavigates the continuous hairpin winding when rolled into the cylindrical shape required for the stator. In other words, the number of turns also refers to the number of times a given hairpin wire is running along the hairpin winding when in substantially planar shape before being rolled into the cylindrical shape, e.g. running in forward direction along the planar shape, or after having made a return-bent running in backward direction along the planar shape. Each wire can be arranged such that in a given turn the wire adjacent to another turn of the same wire. In particular, each wire can be arranged such that in a given turn the wire is adjacent to the same wire in another turn such that adjacent turns of the same wire are useful for contributing to the magnetic field to be generated by the continuous hairpin winding. In another embodiment, each wire can be arranged such that in a given turn the wire is not adjacent to another turn of the same wire. In another embodiment, each wire can be arranged such that a given turn is offset to the same wire in another turn by one or more pole distances of a corresponding rotor. In the latter case, the wires have a so called pole offset, wherein the non-adjacent turns of the same wire contribute to magnetic fields to be generated by the continuous hairpin winding at corresponding non-adjacent poles of a rotor.

In an embodiment, the continuous hairpin winding has two sets of phase windings, a first set of phase windings running or traveling around or circumnavigating the cylindrical shape of the stator in a first direction and a second set of phase windings circumnavigating the stator in a second direction counter to the first direction, both sets having input leads on a same end of the stator when seen in an axial direction of the stator, and within an azimuthal angle range φ of less than 60 degrees, preferably less than 45 degrees. The second set of phase windings may also be referred to as counter phase windings. Therefore, each phase winding of the first set of phase windings has a corresponding counter phase winding of the second set of (counter) phase windings. A phase winding of the first set and a corresponding phase winding of the second set are electrically operated in-phase, with the phase windings arranged such that the wires of the phase winding of the first set and the corresponding wires of the corresponding phase winding generate mutually reinforcing electromagnetic fields.

In an embodiment, the substantially cylindrical inner surface and/or the substantially cylindrical outer surface of the casing extends or extend along more than one third, preferably more than half, more preferably more than two thirds, of the axial extension of the ring-cylindrical ironless stator. In other words, the casing supports and holds the ring-cylindrical ironless stator along a large portion of its axial extension. This increases the stability of the assembly of the casing and the ironless stator. Further, this embodiment creates the advantage that connecting elements between the casing and the ring-cylindrical ironless stator can be assembled more easily on relevant portions of the apparatus. In addition, this embodiment reduces the possibilities of unbalances during the operation of the rotating electromechanical apparatus. According to another embodiment, the substantially cylindrical inner surface and/or the substantially cylindrical outer surface of the casing extend along the entire axial extension of the ring-cylindrical ironless stator. This embodiment further increases the overall stability of the rotating electromechanical apparatus and in particular helps to hold the entire ring-cylindrical ironless stator comprising the hairpin windings in the desired shape. In addition, if the ironless stator is entirely arranged within the casing, it is advantageously protected from mechanical damage, shocks, and contaminations. If the ironless stator is only partially covered by the casing, at least the covered portion of the ironless stator is protected by the casing.

In an embodiment of the rotating electromechanical apparatus or method for manufacturing a continuous hairpin winding, an outer radius of a folding region, in particular folded segment, of the wire does neither extend beyond an outer surface or enveloping plain of the first layer nor beyond an outer surface or enveloping plain of the second layer.

In an embodiment where a given phase winding of the first set of phase windings and a corresponding phase winding of the second set of phase windings is formed of a same single uninterrupted wire, the wire preferably has an even number of total turns in the continuous hairpin winding, more preferably six turns or ten turns. In this embodiment, the continuous hairpin winding preferably consists of three wires, each forming, in a number of turns, a given phase winding, and in the same number of turns, a counter phase winding.

In an embodiment, the rotating electromechanical apparatus is configured as an electrical motor driven by current supplied to the continuous hairpin winding. A torque is thereby generated in the rotor.

In an embodiment, the rotating electromechanical apparatus is configured as an electrical generator which generates an electric current from a torque applied to the rotor.

In an embodiment, the rotor is ring-cylindrical such that the rotating electromechanical apparatus has an empty inner cylindrical region. The rotating electromechanical apparatus, can further comprise an additional stator inside the ring-cylindrical rotor. In particular, the additional stator can have an additional continuous hairpin winding, in particular being designed as the continuous hairpin winding as disclosed herein. The additional stator can be used to additionally drive the rotor. The additional stator can be mounted on a support of the rotating electromechanical apparatus.

In an embodiment, the continuous hairpin winding can be encapsulated and/or fixed to the casing by a curable potting material.

In an embodiment, the casing can comprise a stack of laminated magnetically permeable material, preferably an iron alloy. This lamination stack reduces eddy current losses and optimizes the magnetic flux lines. The lamination stack has a ring-cylindrical shape. It can comprise a plurality of ring cylindrical iron alloy plates which are laminated in an electrically insulating material such that eddy currents cannot pass from one iron alloy plate to another.

In an embodiment, the casing can comprise a strip of laminated magnetically permeable material, preferably an iron-alloy, wound helically to form or form part of a ring-cylindrical casing. Herein, laminated means that the magnetically permeable material comprises an insulation layer or insulation coating at least on one main surface or on both main surfaces. Main surfaces mean those surfaces of the strip which face each other or even touch each other when the strip is wound in helical form. Specifically, a continuous strip of laminated magnetically permeable material of constant thickness and width is helically wound around a cylindrical support, thereby forming a helical lamination stack, which forms or forms part of the ring-cylindrical casing. The helical lamination stack has the advantage that eddy currents cannot travel directly along a cylinder axis of the casing, but instead must travel along a much longer helical path around the cylinder axis of the casing. The casing, as explained above and throughout the application, shall preferably not extend into a region of the stator, in particular into a region of the continuous hairpin winding. The thin strip of laminated material reduces eddy current losses. The advantage of winding the strip helically to form the ring-cylindrical shape instead of stacking thin plates is that the production is simplified and therefore the time and also costs of manufacture are significantly reduced. Additionally, the ring-cylindrical casing made from one continuous strip can result in a ring-cylindrical casing which is self-supporting and forms an integral structure. In particular, the ring-cylindrical casing thus formed does not require pins to be inserted through axial through-holes to provide structural support, as is the case with stacking thin plates. By avoiding such axial through holes and pins, the casing can be manufactured to be thinner for achieving the same structural stability and does not require additional manufacturing steps.

In addition to a rotating electromechanical apparatus, the present invention also relates to a method for manufacturing a continuous hairpin winding for an ironless stator. In particular, the method relates to manufacturing a continuous hairpin winding for a stator or for an additional stator for a rotating electromechanical apparatus as described herein. The method comprises the step of arranging a plurality of wires straight side by side in a ribbon. Arranging the plurality of wires in a ribbon can be done in a prior step, for example when winding the plurality of wires onto a drum, preferably a drum large enough that the wires are only elastically bent and therefore come off the drum unbent and straight. Arranging the plurality of wires can also be done by bringing together side by side the plurality of wires from different drums. The wires are unbent and are arranged to lie parallel to each other in a ribbon, preferably with short sides of the wires facing each other. Depending on the embodiment, the wires are arranged closely together or are arranged with gaps in-between the wires. The method also comprises the step of folding-over the ribbon of the plurality of wires in a first direction of rotation, in particular folding the ribbon successively along successive fold lines present along a longitudinal axis of the ribbon (with the longitudinal axis of the ribbon lying parallel to a longitudinal axis of each wire), the fold lines being at an oblique angle to the longitudinal axis of the ribbon such that the successively folded-over ribbon forms a flattened helical ribbon providing a first layer and a second layer. Each layer of the ribbon can substantially be flat. The oblique angle is a non-orthogonal angle and corresponds to the winding angle or helix angle of the flattened helical ribbon. The winding angle depends on a number of parameters, including a width of the ribbon (which itself can be chosen as a function of a number of phase windings, a number of wires of each phase winding, the cross-sectional width of each wire, and the distance between adjacent wires) and the distance between the successive fold lines. The fold lines can be evenly spaced along the ribbon such that the folded-over ribbon forms the flattened helical ribbon. The method also comprises bending, into each wire of the completed flattened helical ribbon, a straight segment between each successive fold line such that the straight segments run substantially perpendicular to the fold lines of the flattened helical ribbon. The bending step introduces the hairpin shape into the wires. In particular, each wire is bent about an axis perpendicular to a plane of the ribbon such that each layer of the folded-over ribbon remains flat. In other words, each wire of each layer of the ribbon is bent laterally such that a first offset bend is created before each fold line and a second offset bend is created after each fold line. Thereby, a quasi-helical ribbon is formed that has hairpin-shaped segments which include straight segments between two bent segments. The method also comprises the step of rolling the flattened quasi-helical ribbon into a cylindrical shape to form a ring-cylindrical continuous hairpin winding, with the straight segments running substantially parallel to a cylinder axis of the cylindrical shape.

In an embodiment, the method can further comprise the step of potting the continuous hairpin winding using a curable potting material. The potting material is, for example, a two-part potting material or a curable potting material (using, for example, UV-curing). Although the continuous hairpin winding already has considerable structural stability due to its continuously interlaced hairpin winding, the potting material can be introduced into the continuous hairpin winding to further improve the structural stability, to further improve the electrical isolation between the wires, and to improve removal of heat due to resistive losses away from the wires.

In an embodiment, the method can further comprise inserting the continuous hairpin winding into a casing having a substantially cylindrical inner surface for mounting the continuous hairpin winding in the rotating electromechanical apparatus. Please note that compared to prior art techniques, the inserting step does not involve placing the hairpin winding in grooves or notches of the casing or stator iron, and the casing of the invention thus can be free of slots, grooves or notches. The inserted continuous hairpin winding may e.g. be bonded to the inner casing. The inserted continuous hairpin winding may be bonded to the casing in conjunction with the potting step mentioned above, in particular using the same curable potting material. This combination of steps increases the speed of manufacture and further ensures a very good fit between the continuous hairpin winding and the casing. Additionally, or alternatively, the method can further comprise inserting the continuous hairpin winding into a casing having a substantially cylindrical outer surface for mounting the continuous hairpin winding in the rotating electromechanical apparatus. This configuration can be used when the rotating electromechanical apparatus has an external rotor. Additionally, the method can further comprise adding a second continuous stator winding to the rotating electromechanical apparatus by mounting the second continuous hairpin winding on a support of the rotating electromechanical apparatus, the second continuous hairpin winding being coaxial with the first continuous hairpin winding and the rotor being arranged in-between.

In an embodiment, the continuous hairpin winding can comprise a plurality of interlaced phase windings, each consisting of a single uninterrupted wire having multiple turns around the ring-cylindrical shape of the stator, preferably three turns or five turns. The single uninterrupted wire need not have any electrical joins along its length. Multiple turns are formed by arranging the plurality of wires, one wire for each phase winding, straight side by side in the ribbon leaving gaps between the wires. Each gap is wide enough to receive a wire, and there may be multiple gaps between two adjacent wires. The ribbon of the plurality of wires is folded over in the first direction of rotation, in particular folding the ribbon successively along successive fold lines present along the longitudinal axis of the ribbon which forms the flattened helical ribbon, the flattened helical ribbon having gaps. The method comprises return-bending of the plurality of wires by bending the plurality of wires by a total of 180 degrees in a return-bending zone. Each wire is return-bent such that, subsequent to return-bending, a gap in the ribbon is occupied. The method comprises folding-over the plurality of wires around the flattened helical ribbon in a second direction of rotation counter to the first direction of rotation such that the plurality of wires is folded-over into the gaps of the flattened helical ribbon. The steps of return-bending and folding-over are repeated until a desired number of turns are obtained. Once the desired number of turns are obtained, all gaps in the ribbon are filled and the flattened helical ribbon has two layers, each layer comprising wires arranged side-by-side.

In an embodiment, the return-bending zone comprises one or more bending axes perpendicular to a plane of the flattened helical ribbon, in particular along a z-direction, and the return-bending the wires comprises bending each single wire about the one or more bending axes. Return-bending the wires comprises, for example, bending each single wire twice about 90°, the two 90° bends being separated by a pre-determined distance such that the return-bent wire occupies an appropriate gap in the flattened helical ribbon.

In an embodiment, the continuous hairpin winding can have two sets of phase windings made of separate continuous hairpin windings. To form the single continuous hairpin winding, the two separate continuous hairpin windings can be stacked or interlaced.

In an embodiment, the continuous hairpin winding can have two sets of phase windings made of a single uninterrupted wire. A particular single wire of a particular phase winding is return-bent in a return-bending zone, being separated by a pre-determined distance such that the return-bent wire occupies a particular gap for a corresponding wire of the second set of phase windings. The single wire can be associated with a first set of phase windings before the return-bending and a second set of phase windings after the return-bending, or vice versa. The first segment of the wire before the return-bending zone and the second segment of the wire after the return-bending zone can both belong to the same layer selected from the first and second layer.

With the return-bending of the plurality of wires it is possible to create the continuous hairpin winding comprising the plurality of interlaced phase windings, wherein each phase winding consists of the single uninterrupted wire having multiple turns around the stator, preferably three turn or five turn. In this embodiment even fewer, or even no electrical joins, e.g. by welding or similar, can be required, because each phase winding can consist of only a single uninterrupted wire. The number of turns refers to the number of times a given hairpin wire circumnavigates the continuous hairpin winding when rolled into the cylindrical shape required for the stator. In other words, the number of turns also refers to the number of times a given hairpin wire is running along the hairpin winding axis when in substantially planar shape before being rolled into the cylindrical shape, e.g. running in forward direction along the planar shape, or after having made a return-bent running in backward direction along the planar shape. Each wire can be arranged such that in a given turn the wire is adjacent to another turn of the same wire. In particular, each wire can be arranged such that in a given turn the wire is adjacent to the same wire in another turn such that adjacent turns of the same wire are useful for contributing to the magnetic field to be generated by the continuous hairpin winding. In another embodiment, each wire can be arranged such that in a given turn the wire is not adjacent to another turn of the same wire. In another embodiment, each wire can be arranged such that a given turn is offset to the same wire in another turn by one or more pole distances of a corresponding rotor. In the latter case, the wires have a so called pole offset, wherein the non-adjacent turns of the same wire contribute to magnetic fields to be generated by the continuous hairpin winding at non-adjacent poles of the rotor.

In an embodiment, the bending comprises bending, into each of the plurality of wires, two offset bends, thereby providing the straight segments, which are present between the offset bends, parallel and displaced to one another. Thereby, the quasi-helical shape of the ribbon after bending is formed. Each offset bend can include a first bend about a particular angle and a second bend about the same particular angle in the opposite direction, such that the straight segments on either side of the off-set bend remain parallel. The particular radius of bending and angle of bending depends on the application, in particular it depends on the aspect ratio of the wire and the type and thickness of insulation around each wire.

In an embodiment, after the rolling the continuous hairpin stator into the cylindrical shape, the continuous hairpin winding forms an overlap area, in which the first layer formerly, i.e. before rolling, at a first end of the flattened helical ribbon overlaps with the second layer formerly, i.e. before rolling, at a second end of the flattened helical ribbon. This overlap area is the result of the folding-over of the ribbon which results in the flattened helical ribbon having the first layer and the second layer which are partially displaced in a planar direction relative to one another such that the first layer has a protrusion on one end of the flattened helical ribbon, and the second layer has a protrusion on the other end of the flattened helical ribbon, which protrusions are complementary such that when the continuous hairpin winding is rolled into the cylindrical shape the first layer and the second layer fit together and form a continuous inner cylindrical layer and continuous outer cylindrical layer, respectively, each having a substantially uniform distribution of wires.

In an embodiment, the method described above for manufacturing a continuous hairpin winding includes using a folding apparatus comprising a folding member. The folding member has a first face and a second face, spacing elements, and a folding axis about which the folding member is rotatable. The folding-over of the ribbon of the plurality of wires comprises placing the ribbon of the plurality of wires across the first face of the folding member at an oblique angle with respect to the folding axis, the plurality of wires being separated by the spacing elements. The spacing elements are, for example, protrusions from, or recesses into, the folding member which are configured to receive the wires of the ribbon and space them appropriately. The folding member is rotated around the folding axis, such that the ribbon repeatedly wraps successively around the first face and the second face of the folding member, thereby forming the flattened helical ribbon.

In an embodiment, the folding apparatus further comprises one or more wire combs. The wire combs are, similarly to the spacing elements, configured to hold the wires. Bending the straight segment into each wire of the flattened helical ribbon comprises engaging the one or more wire combs with the wires of the flattened helical ribbon and displacing the one or more wire combs laterally with respect to the lengths of the wires to bend into each wire the offset bends and there-between the straight segments. As a result, the helical ribbon is reshaped into a quasi-helical ribbon. The wire combs are, for example configured to engage with the wires and press the wires against the folding member. The wire combs are then displaced along the folding member.

In an embodiment, at least one of the wire combs is linearly displaced in opposite direction parallel to the folding axis of the folding apparatus with respect to another one of the wire combs for manufacturing the continuous hairpin winding. According to this embodiment, the wire combs create the advantageous possibility to bend the straight segments of the hairpin winding within one displacement step and therefore in particular fast. A further advantage is that the wire combs engage with preferably all wires of the flattened helical ribbon simultaneously. Another advantage is that the wire comb engagement is done without one or more wires being provided under axial tension from a spool.

In an embodiment, the folding member comprises a retaining member, onto which the flattened helical ribbon is folded-over, which is formed by two flat plates arranged in a plane and next to each other and separated by a gap, and manufacturing the continuous hairpin winding further comprises removing the retaining member from the flattened helical ribbon by moving the flat plates together to reduce the gap and withdrawing the flat plates from the folded-over flattened helical ribbon. By having a gap between the flat plates, the flat plates can be removed, e.g. successively, from the flattened helical ribbon easily and without disturbing the folded-over flattened quasi-helical ribbon, which reduces a likelihood of the wire insulation being damaged or the specified shape of the flattened quasi-helical ribbon being compromised.

In an embodiment, the folding apparatus comprises one or more return-bending members, in particular extended along the z-direction out of the plane of the flattened helical ribbon, and return-bending the wires comprises rotating the folding apparatus about the one or more return-bending members, in particular in a first plane of the flattened helical ribbon, which first plane is parallel to the first and second layer before the steps of bending the hairpin shape and, in particular, before the step of rolling. For the step of rotating the folding apparatus about the one or more return-bending members, or about an axis lying in a region of the one or more return-bending members, it may be advantageous that the folding apparatus is arranged on a rotatable table.

In an embodiment, return-bending the single wires comprises return-bending all the wires of a given set about a same return-bending member, each wire of the given set being bent at a different height position on the same return-bending member. Due to the elastic flexibility of the wires, a number of wires can be grouped together into a single set and bent simultaneously about the same return-bending member. To ensure that the resulting bends in the wires do not overlap each other, thereby occupying more space in a vertical direction, each wire is bent at a different height position above the plane of the flattened helical ribbon. This is possible without inelastically bending the wires. As a result, the bends in the wires, when the bends are returned to the horizontal position, are displaced from each other laterally such that the bends do not overlap each other.

In an embodiment, the return-bending the wires comprises return-bending all the wires of a given set about a same first return-bending member and about a same second return-bending member, each wire of the given set being bent at a different height position on the first same return-bending member and the second same return-bending member, such that after complete return-bending, in particular by a total of 180°, each wire of the given set is separated from the other wires of the same set at least by a distance in a plane orthogonal to the z-direction after the wires have been returned to a substantially flat position.

In an embodiment, the return-bending the wires comprises positioning the return-bending members such that after complete return-bending, in particular by a total of 180°, each of the wires does not overlap any other wire in a plane orthogonal to the z-direction.

In addition to a rotating electromechanical apparatus and a method for manufacturing a continuous hairpin winding for an ironless stator, the present invention also relates to a folding apparatus for manufacturing a continuous hairpin winding. The folding apparatus comprises a folding member. The folding member has a first face and a second face, spacing elements, and a folding axis about which the folding member is rotatable. The spacing elements are, for example, protrusions from, or recesses into, the folding member which are configured to receive wires and space them appropriately.

In an embodiment, the folding apparatus further comprises one or more wire combs. The wire combs are, similarly to the spacing elements, configured to hold wires of a flattened helical ribbon. The wire combs are configured to engage with the wires and to bend into each wire the offset bends and there-between the straight segments by displacing the one or more wire combs laterally with respect to the lengths of the wires. The wire combs are, for example configured to engage with the wires and press the wires against the folding member. The wire combs are then displaced along the folding member.

In an embodiment, the folding member comprises a retaining member which is formed by two flat plates arranged in a plane and next to each other and separated by a gap, the retaining member being designed such that the flat plates can be moved towards one another to reduce the gap.

In an embodiment, the folding apparatus comprises one or more return-bending members for return-bending the wires.

In an embodiment, at least one of the wire combs is linearly displaced in opposite direction parallel to the folding axis of the folding apparatus with respect to another one of the wire combs for manufacturing the continuous hairpin winding.

In embodiments of the herein disclosed invention, in particular methods for manufacturing a continuous hairpin winding, the wire combs engage with a plurality of and preferably all wires of the flattened helical ribbon simultaneously.

In embodiments of the herein disclosed invention, in particular methods for manufacturing a continuous hairpin winding, the wire comb engagement is done without one or more wires being provided under axial tension from a spool.

In embodiments of the herein disclosed invention, in particular methods for manufacturing a continuous hairpin winding, the stator windings are not embedded in slots of a stator core.

In embodiments of the herein disclosed invention, the wire can be comprised of a plurality of conductors, e.g. litz wires, in particular round conductors or round litz wires, each wrapped in a conductor insulator. The combined arrangement of the conductors, i.e. the conductor package, can itself be wrapped in an outer insulator. The plurality of preferably round conductors can be arranged relative to one another in a flat shape, in particular parallelogram-like shape, thereby forming a flat wire suitable for continuous hairpin windings with high fill factor and reduced eddy currents.

### BRIEF DESCRIPTION OF THE DRAWINGS

The herein described disclosure will be more fully understood from the detailed description given herein below and the accompanying drawings which should not be considered limiting to the disclosure described in the appended claims. The drawings in which:

FIG. 1: shows schematically a stator winding with wave winding arranged under a tilt angle according to the prior art;

FIG. 2: shows schematically a continuous hairpin winding having a quasi-helical hairpin shape with untilted straight segments according to an embodiment of the invention;

FIG. 3: shows schematically a cross section of a rectangular wire according to an embodiment of the invention;

FIG. 4: shows schematically a cross section of a wire bundle of a wave winding according to prior art and also being useful for the invention;

FIG. 5: shows schematically a detail view in cross section through an apparatus according to an embodiment of the invention;

FIG. 6: shows schematically a rotating electromechanical apparatus according to an embodiment of the invention with cut-away sections to expose the interior of the apparatus;

FIG. 7: shows schematically a single hairpin wire segment according to the prior art;

FIG. 8: shows schematically part of a continuous hairpin winding according to an embodiment of the invention;

FIG. 9a-9c: show schematically three different wire folds according to three embodiments of the invention;

FIG. 10: shows schematically a wire offset bend according to an embodiment of the invention;

FIG. 11: shows schematically three phases of a continuous hairpin winding interlaced with one another according to an embodiment of the invention;

FIG. 12: shows schematically two sets of three phases of a continuous hairpin winding interlaced with one another according to an embodiment of the invention;

FIGS. 13a-13o: show schematically a number of steps and a folding apparatus for manufacturing a continuous hairpin winding according to an embodiment of the invention;

FIGS. 14a-14b: shows schematically two steps of bending offset bends and there-between straight segments into a flattened helical ribbon to form a flattened quasi-helical hairpin-shaped ribbon and a continuous hairpin winding according to an embodiment of the invention;

FIGS. 15a-15c: show schematically a number of steps for rolling a flat continuous hairpin winding into a cylindrical continuous hairpin winding according to an embodiment of the invention;

FIG. 16: shows schematically a wiring diagram of a continuous hairpin winding according to an embodiment of the invention in which the winding has two sets of three phases and each phase of each set consists of a single wire having three turns; and

FIG. 17: shows schematically a wiring diagram of a continuous hairpin winding according to an embodiment of the invention in which the winding has two sets of three phases, wherein a single wire having six turns is used for each phase such that corresponding phases in both sets are jointly formed by the same single wire.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as being limited to the embodiments set forth herein, rather, these embodiments are provided so that this disclosure will satisfy applicable legal requirements. Furthermore, embodiments can also be combined with one another. Whenever possible, like reference numbers will be used to refer to like components or parts. Not all like components have reference numbers in all Figures.

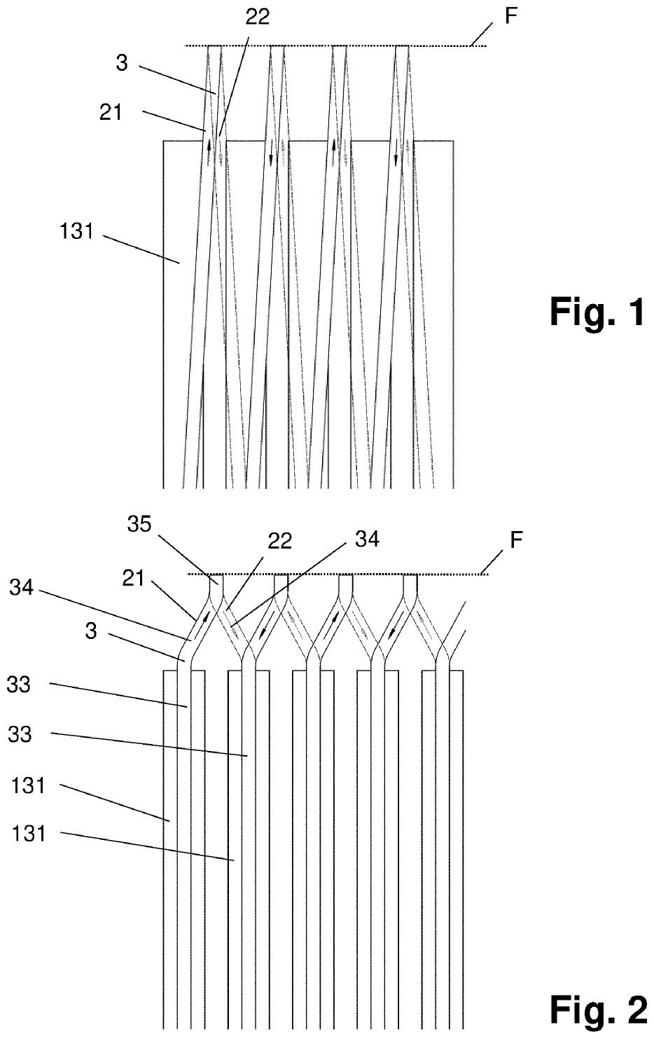

FIG. 1 shows a schematic section view of a prior art stator winding suitable for ironless motors. The stator winding has wires 3 which are wound around a support (not shown), being folded along a fold line F. The wires 3 are densely packed next to each other, however for illustrative purposes, not all wires 3 are shown. The current in next-neighboring wires 3, i.e. subsequent wires or wire segments 3 before and after the fold line F, travel in opposite directions. Further, the stator winding has a first side 21 and a second side 22 and the current in each wires travels in a first direction on the first side 21 and in an opposite direction (relative to the winding as a whole) on the second side 22. Poles 131 of the rotor 13 (not shown explicitly) are also depicted. The distance between next-neighbouring wires 3 or wire segments corresponds to a center-to-center distance between the poles 131. The stator winding as depicted has a number of drawbacks. Firstly, the individual wires 3 are at a tilt angle with respect to the poles 131, i.e. form a strict helix, and therefore the electromagnetic field generated by the stator winding does not optimally interact with the (electro)magnetic field of the poles 131 because they are at the small tilt angle to each other. Further, the wires 3 on the first side 21 have a large overlapping region with the wires 3 on the second side 22 which results in partial cancellation of the generated electromagnetic field in this region. To avoid this large overlapping region, typically a longitudinal extension of the poles 131 of the rotor is less than a longitudinal extension of the stator winding. It can be seen in the figure that the fold line F is arranged at a substantial distance away from the end of the rotor poles 131.

FIG. 2 shows a schematic section view of a continuous hairpin winding 2 according to an embodiment of the invention. As in FIG. 1, not all wires 3 are shown. Similar to FIG. 1, the current in wires 3 and next-neighboring wires 3 travels in opposite directions. Further, the continuous hairpin winding 2 has a first layer 21 and a second layer 22 and, as is indicated by the direction of the arrows in each wire 3, the current in each wire 3 travels in a first direction in the first layer 21 and in an opposite direction (along the continuous hairpin winding 2 as a whole) in the second layer 22. Poles 131 of the rotor 13 (not shown explicitly) are also depicted. The distance between next-neighbouring wires 3 corresponds to a center-to-center distance between the poles 131.

In comparison with the prior art FIG. 1, the wires 3 of the present embodiment have straight segments 33 which are aligned with the poles 131 to ensure optimal electromagnetic interaction. Secondly, a region of overlap which includes the folded segment 35 between a given wire 3 in the first layer 21 and the same wire 3 in the second layer 22 is removed from an end region of the rotor poles 131 entirely to avoid performance losses due to cancellation of the induced electromagnetic field in the end region of the rotor poles 131. Depending on the configuration, in particular the bending angles of the wires 3, the fold line F can be moved closer to the end region of the poles 131 in comparison to the prior art, allowing for a more compact design of the continuous hairpin winding 2.

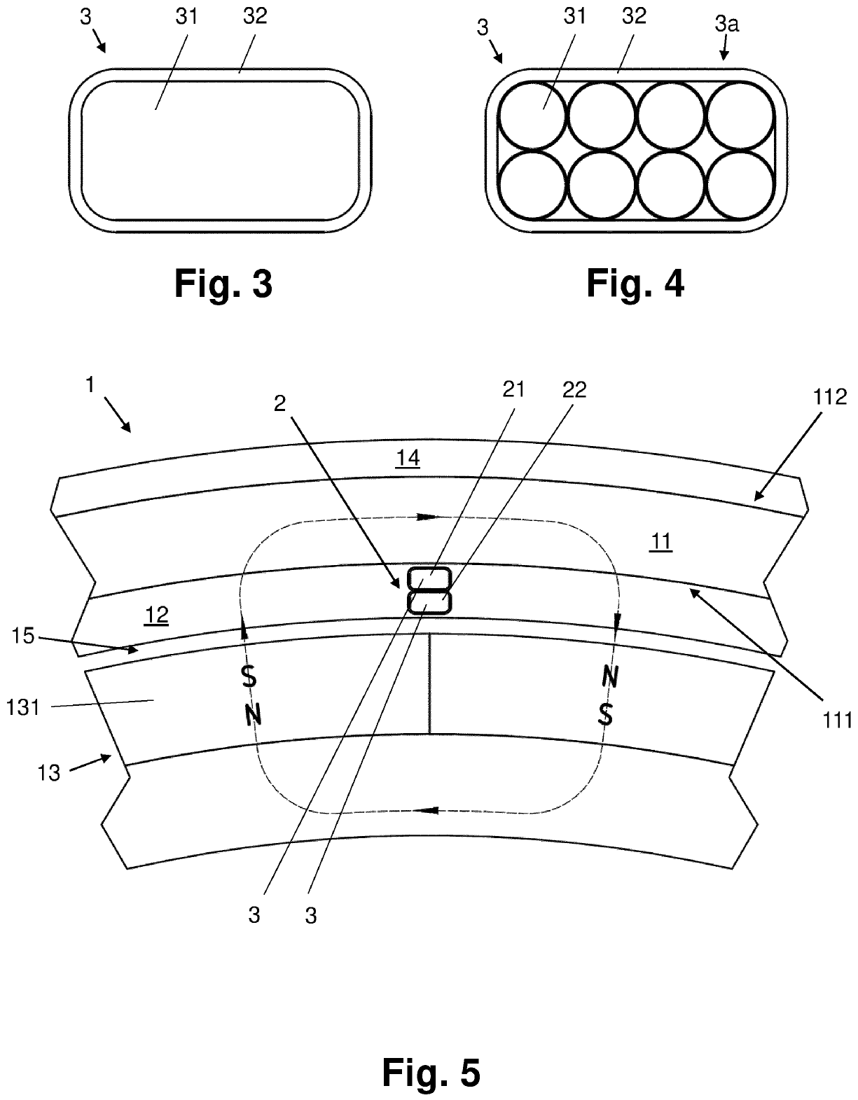

FIG. 3 shows a cross-sectional view of a wire 3 according to an embodiment of the invention. The wire 3 has a substantially rectangular cross section with rounded corners. The wire 3 has an inner conductor 31, preferably being copper or an alloy of copper, and an outer insulator 32. The wire 3 can be manufactured, for example, by rolling a round wire into a rectangular shape, or directly by extrusion e.g. in rectangular shape. Alternatively, the wire 3 has an oval or otherwise flattened shape. The aspect ratio of the wire 3 (the ratio of the cross-sectional height to the cross-sectional width) can lie between 1:1 and 5:1, preferably being 2:1.

FIG. 4 shows a cross-sectional view of the wire 3 according to the prior art. The wire 3 is comprised of a plurality of round conductors 31 wrapped in an outer insulator 32. Compared to the embodiment of FIG. 3, the wire 3 has a lower fill factor due to the spaces between the round conductors 31. Nevertheless, such prior art wire 3 may also be used in the invention.

According to another embodiment, the wire 3 is comprised of a plurality of conductors 31, in particular round conductors 31, e.g. litz wires, each wrapped in a conductor insulator as indicated in FIG. 4 by the circles which encapsulate the conductors 31. A combined arrangement 3a of the conductors 31, i.e. the conductor package 3a, may itself be wrapped in an outer insulator 32. According to a further embodiment, the plurality of round conductors 31 are arranged relative to each other in a parallelogram like shape (i.e. hexagonal packing). In other words, four of the central axis of the conductors 31 form the corners of a parallelogram. This shape increases the fill factor of the wire 3 (the conductor package 3a), due to the reduction of spaces between the conductors 31.

The conductor package 3a, in particular the conductor package 3a containing litz wires 31, shown in FIG. 4 has further advantages over a single rectangular or flat wire 3 as shown in FIG. 3. The conductor package 3 is more flexible and thus easier to be bent into the flattened quasi-helical ribbon. The conductor package 3a also allows to reduce eddy current losses in the continuous hairpin winding and thus in the rotating electromechanical apparatus. The reduction of eddy current losses can be attributed to the smaller conductive cross-sectional areas bounded by the conductor insulators inside the conductor package 3a.

FIG. 5 shows highly schematically a cross-sectional 2D section view of a rotating electromechanical apparatus 1 according to an embodiment of the invention. The apparatus 1 has a casing 11 which has a substantially cylindrical inner surface 111 and a substantially cylindrical outer surface 112. The casing 11 is comprised of a lamination stack made of thin magnetically permeable material, in particular an iron-alloy. In an embodiment, the casing 11 is comprised of thin strip of helically wound laminated magnetically permeable material, in particular an iron-alloy. The ironless stator 12 is arranged on the inside of the apparatus 1, next to the casing 11. The casing 11 does not extend into a region of the ironless stator 12. The ironless stator 12 includes a continuous hairpin winding 2. To reduce clutter, only a part of the continuous hairpin winding 2 is shown. In particular, two wires 3 are shown which belong to a first layer 21 and a second layer 22 of the continuous hairpin winding 2, the two layers 21, 22 being arranged above one another in a radial direction from a center axis of the cylindrical stator 12. The apparatus is shown with a shell 14 which may enclose the casing 11. A rotor 13 is arranged e.g. inside and separated from the ironless stator 12 by a ring-cylindrical gap 15. Poles 131 of the rotor 13 interact with an electromagnetic field generated by the stator 12 to generate torque. Electromagnetic field lines are drawn to illustrate how the casing 11 and the rotor 13 closes the field lines effectively.

Depending on the embodiment, the rotor 13 is a permanent magnet rotor, a “squirrel cage” type rotor for an asynchronous induction electromagnetic apparatus 1 or a reluctance-type rotor. While the disclosed continuous hairpin winding 2 is particularly suitable for an ironless stator 12 in a synchronous AC motor or generator in which the rotor 13 has permanent magnets, it is also suitable for use in other types of stator windings for other types of electromagnetic apparatuses, and can also be used as a short-circuited cage winding for an asynchronous rotor.

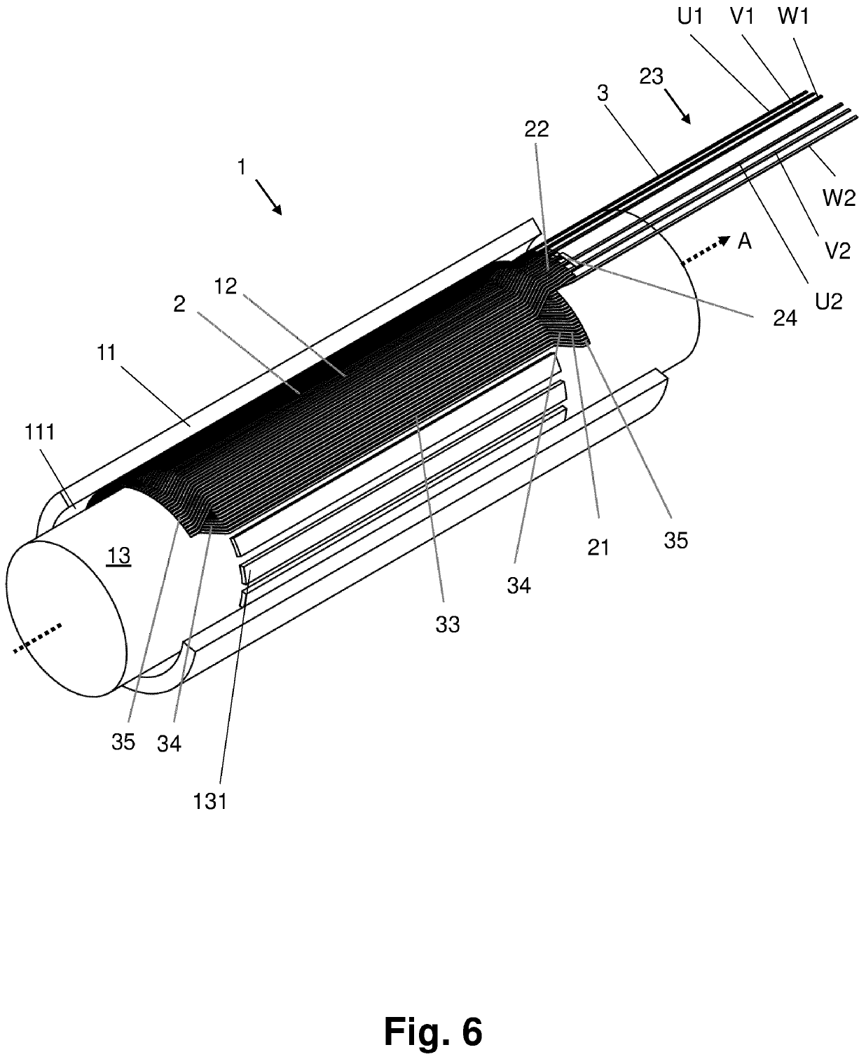

FIG. 6 shows a highly schematic perspective view of an electromechanical apparatus 1 according to an embodiment of the invention with a cut-out to show its interior. The casing 11 encloses a cylindrical region. The continuous hairpin winding 2 is arranged against an inner surface 111 of the casing 11 (only a part of the continuous hairpin winding 2 is shown for illustrative purposes). A rotor 13 is arranged coaxial with the continuous hairpin winding 2 about a cylinder axis A. Poles 131 of the rotor interact with an induced electromagnetic field of the continuous hairpin winding 2 to generate torque in the rotor 13. The continuous hairpin winding 2 has two layers, an inner layer 21 and an outer layer 22. The continuous hairpin winding 2 has two sets of three phase windings U1, V1, W1, U2, V2, W2 wherein a phase winding U1 of the first set and a corresponding phase winding U2 of the second set have the same electrical phase (and e.g. may be joined together, not shown in FIG. 6). The continuous hairpin winding 2 has input leads 23 for each of the phase windings U1, V1, W1, U2, V2, W2 in the same region of the rotating electromechanical apparatus 1 such that electrical connection of the continuous hairpin winding 2 is efficient and uncomplicated. In particular, all input leads are within a common, preferably small, azimuthal angular region. An end of each phase winding U1, V1, W1, U2, V2, W2 is electrically joined to at least one other phase winding of the phase windings U1, V1, W1, U2, V2, W2, for example to form a star ground 24 or delta connection. A longitudinal extension of the poles 131 of the rotor 13 does not extend beyond a region of the straight segments 33 of the continuous hairpin winding 2.

As can be seen in FIG. 6, the casing 11 radially encloses the entire ironless stator 12 as well as the rotor 13. Specifically, the casing 11 extends around the entire outer surface of the ironless stator 12, which houses the continuous hairpin winding 2. In particular, the continuous hairpin winding 2 is covered by the casing 11 along its entire axial extension (i.e. its extension parallel to the central axis A). The casing 11 and in particular the inner surface 111 of the casing 11 is arranged adjacent to the ironless stator 12 and thereby holds the ironless stator 12, and in particular the continuous hairpin windings 2 in position. The ironless stator 12 entirely arranged within the casing 11 is thereby protected from mechanical damage, shocks, and contaminations by the casing 11. In an embodiment where the ironless stator 12 is only partially covered by the casing 11 (not shown in FIG. 6), at least the covered portion of the ironless stator 12 is protected by the casing 11.

The electromechanical apparatus has the technical advantage of having a stator 12 of small radial extension in comparison to a radial extent of the casing 11.

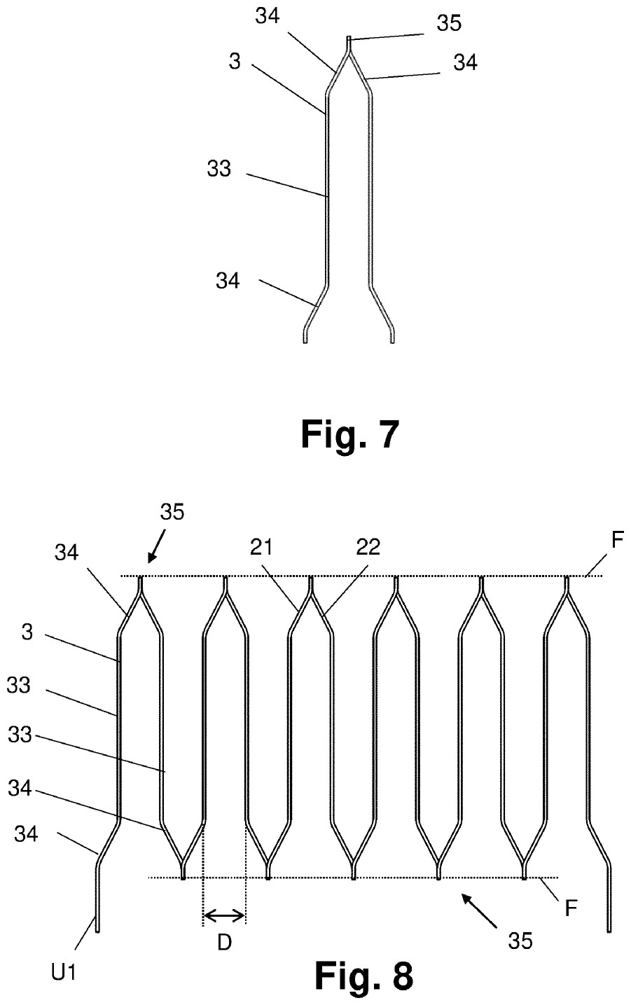

FIG. 7 shows schematically single wire 3 having a characteristic hairpin shape according to the prior art. A straight segment 33 is arranged between bent segments 34, which bent segments 34 are separated by a folded segment 35. According to the prior art, multiple such single hairpins are inserted into a slotted stator iron and electrically joined together using, for example, laser beam welding.

FIG. 8 shows schematically a single wire 3 of a phase winding U1 of a continuous hairpin winding 2 according to an embodiment. For ease of understanding only a single phase winding U1 having a single wire 3 is shown, in FIG. 12 multiple phase windings U1, V1, W1, U2, V2, W2 are shown. The single wire 3 has a folded segment 35 which is folded at fold lines F such that some segments of the wire 3 are in a first layer 21 and other segments of the wire 3 are in a second layer 22. Further, the bent segments 34 include an offset bend, in particular a first offset bend before the fold line and a second offset bend after the fold line, such that adjacent straight segments 33 are displaced by a distance D. The transition from one straight segment 33 of the first layer 21 to the next straight segment 33 of the second layer 22 runs along the first bent segment 34, the folded segment 35 and the second bent segment 34. The bent segments 34 are arranged at a predefined angel to the straight segments 33 and extend straight until the folded segment 35. The transition from one straight segment 33 to the next straight segment 33 does not run along a semicircle, an arc or another bended segment having a continuous radius, as is usual in so-called wave winding.

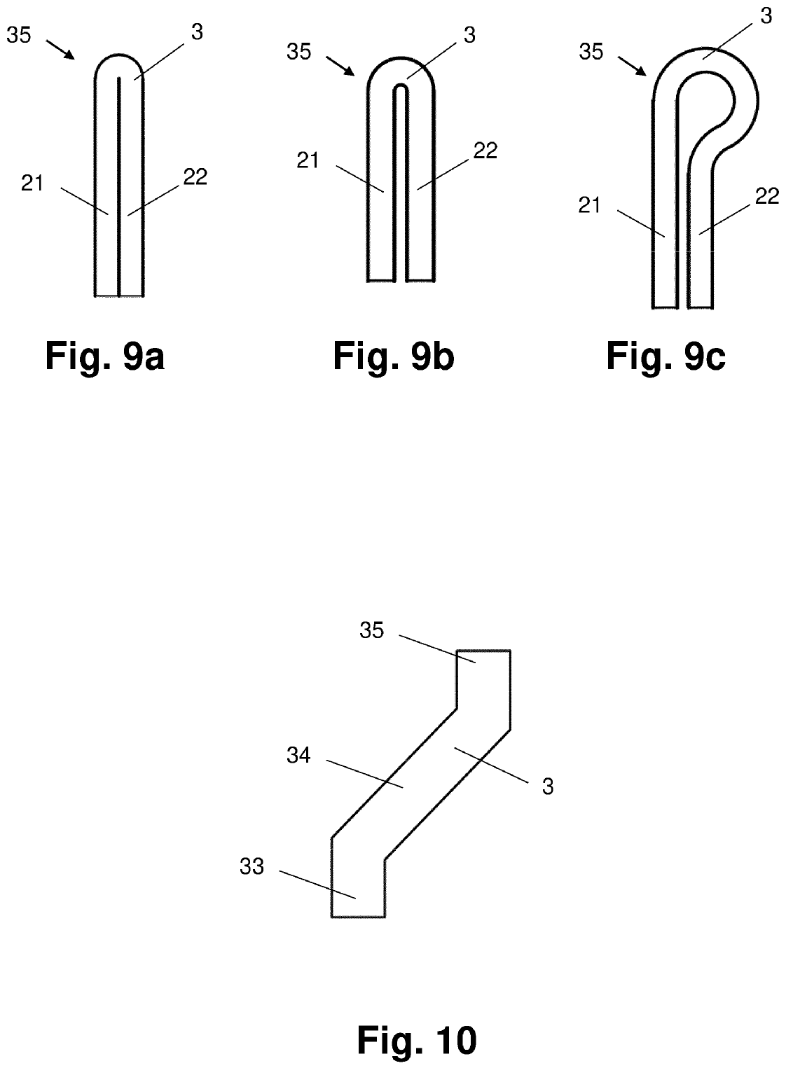

FIGS. 9a-9c show schematically a side-on view of the folded segment 35 and the bent segments 34 in the wire 3 according to various embodiments of the invention. In FIG. 9a, the wire 3 is folded over without a gap between the first layer 21 and the second layer 22. In FIG. 9b the wire 3 is folded over leaving a gap between the first layer 21 and the second layer 22. In FIG. 9c the wire 3 is folded over in a “P” shape in which the folded segment 35 has a greater radius of curvature than in FIGS. 9a and 9b. This requires more space, however the wire insulator is not as compressed and stretched. In this embodiment, it is preferred that the casing 11 has an annular recess configured to receive the bent segment 35 to reduce an overall thickness of the stator 12 and casing 11 combination (not shown). In the embodiments as shown in FIGS. 9a and 9b, the outer radius of a folding region 35, in particular of the folded segment 35, of the wire 3 does neither extend beyond the outer surface of the first layer 21 nor beyond the outer surface of the second layer 22.

FIG. 10 shows highly schematically a bent segment 34 of a wire 3 as an offset bend arranged between a straight segment 33 and a folded segment 35.

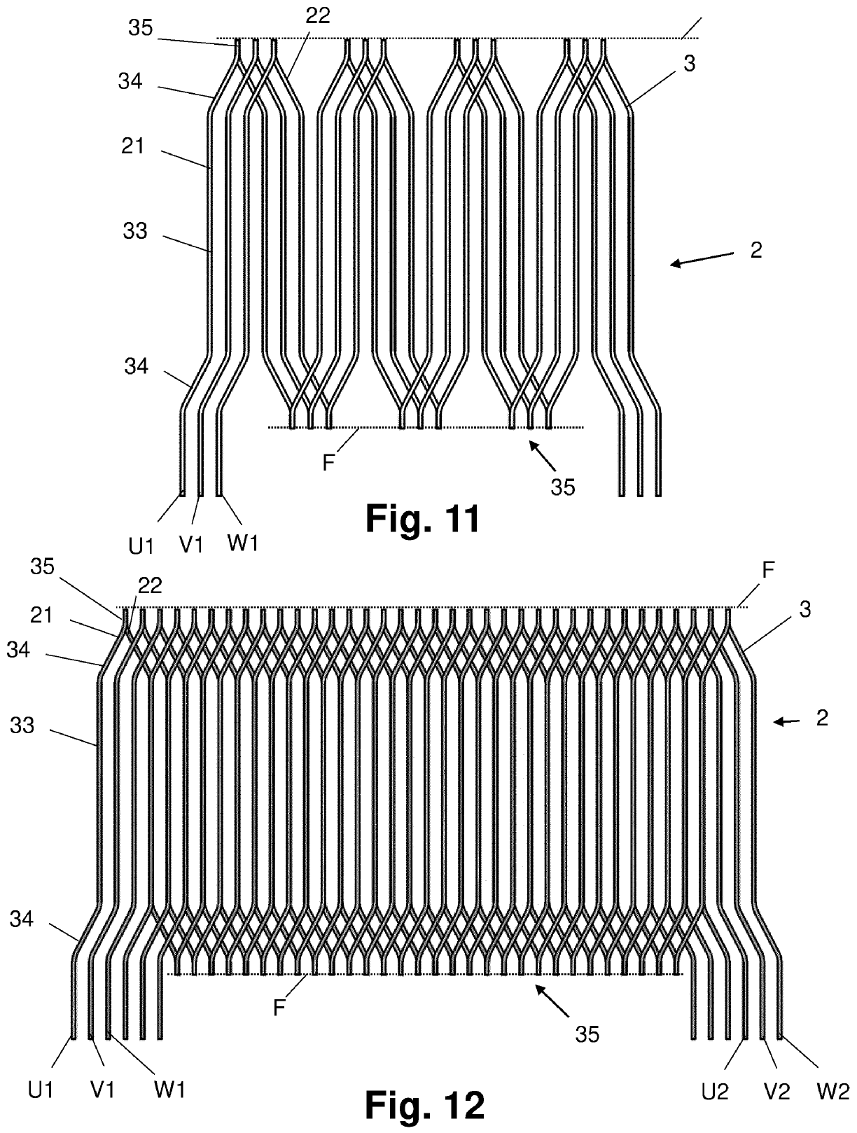

FIGS. 11 and 12 show highly schematically a continuous hairpin winding 2 having one set of phase windings U1, V1, W1 and two sets of phase windings U1, V1, W1, U2, V2, W2, respectively. For clarity of illustration, each phase winding U1, V1, W1, U2, V2, W2 is shown having only a single wire 3, however one or more adjacent wires 3 for each phase winding U1, V1, W1, U2, V2, W2 are foreseen, in particular three or five adjacent wires 3 for each phase winding U1, V1, W1, U2, V2, W2 such that the first layer 21 and the second layer 22 are densely packed with wires 3. As explained in previous figures, in particular FIGS. 7 and 8, the wires have straight segments 33 with bent segments 34 and folded segments 35 there between, the folded segments 35 being folded along the fold line F. In FIG. 12, the second set of phase windings U2, V2, W2 are arranged relative to the first set of phase windings U1, V1, W1 such that the generated electromagnetic field is complementary, in particular by arranging each wire 3 of a given phase winding U1, V1, W1 of the first set such that it overlaps a wire 3 of a corresponding phase winding U2, V2, W2 of the second set (i.e. one wire 3 is in the first layer 21 and the other is in the second layer 22), and by arranging that current flows in a same direction in those overlapping wires 3.

There are known methods for manufacturing continuous hairpin windings which are suitable for use in electric motors in which the stator iron has slots for arranging the hairpin windings. These known methods comprise first bending offset bends into wires and then wrapping the bent wires around a plate or bobbin. These known methods are not suitable for manufacturing a continuous hairpin winding 2 for an ironless stator 12 of an electromechanical apparatus 1 according to the invention. They are not suitable because many continuous hairpin windings according to the prior art are not or less self-supporting and have less precise tolerances, particularly regarding the uniformity of spacing between wires. This is typically not an issue with iron stators having slots, because the continuous hairpin winding is in any case introduced into the slots which introduces a slight deformation in the stator winding. Further, the slots provide additional structural support to the continuous hairpin winding so it is not as critical for the continuous hairpin winding to be structurally self-supporting.

The known methods in the prior art for manufacturing continuous hairpin windings cannot achieve the same uniformity in the continuous hairpin winding 2 as the manufacturing method according to the invention described herein. In particular, they cannot achieve the required spacing regularity between the wires 3 necessary for a highly efficient and compact high performance ironless stator 12 of an electromechanical apparatus 1. This is because the known methods include first bending offset bends into the wires before folding over the wire. As the bent wires in the known methods must be folded under some tension, a straightening of the offset bends occurs which reduces the regularity of the obtained winding. As an alternative, the wires can be folded with less tension, which however requires complex wire de-tensioning means or requires a very slow folding over of the wires and can result in bowing of the obtained winding.

In stark contrast, the method of manufacture according to the invention as described herein allows for a simplified, highly precise and fast manufacture of self-supporting and precisely shaped quasi-helical continuous hairpin windings perfectly matched to the geometrical needs of an electromechanical apparatus, in particular comprising an ironless stator.

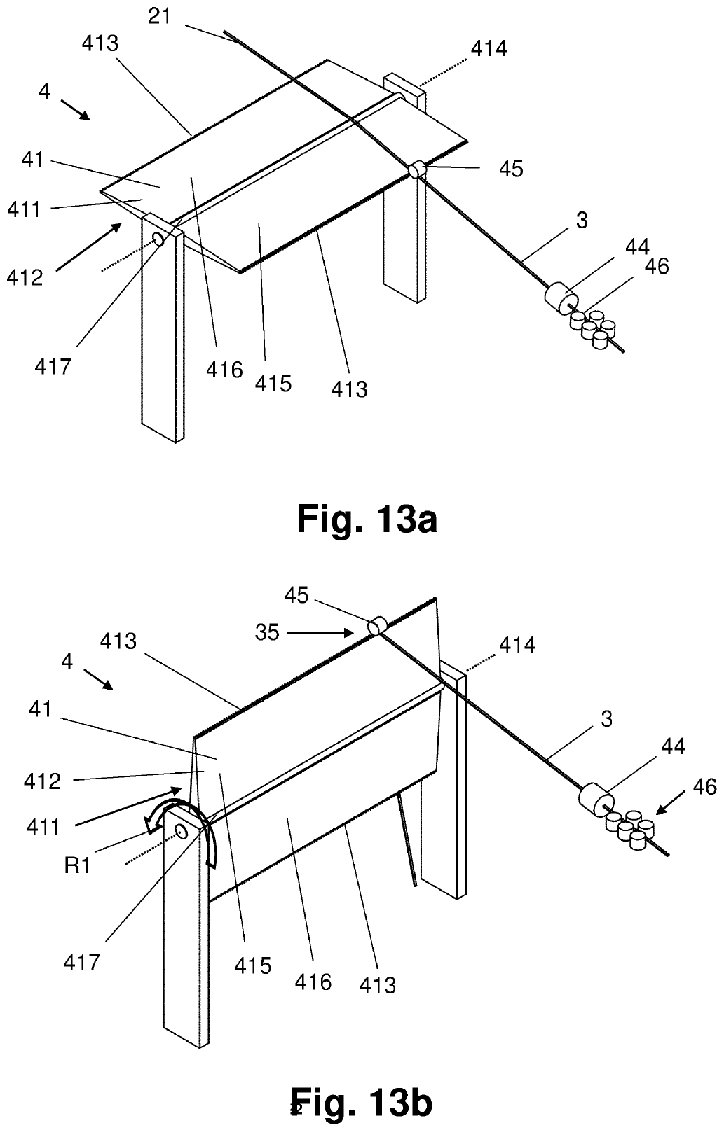

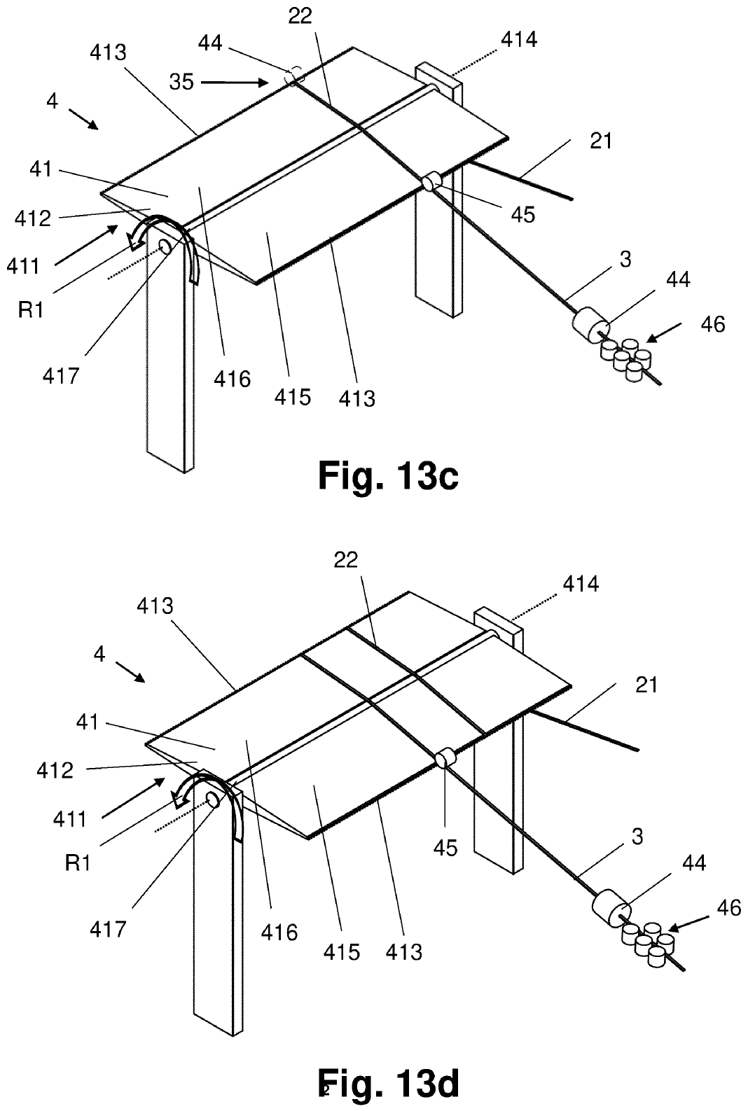

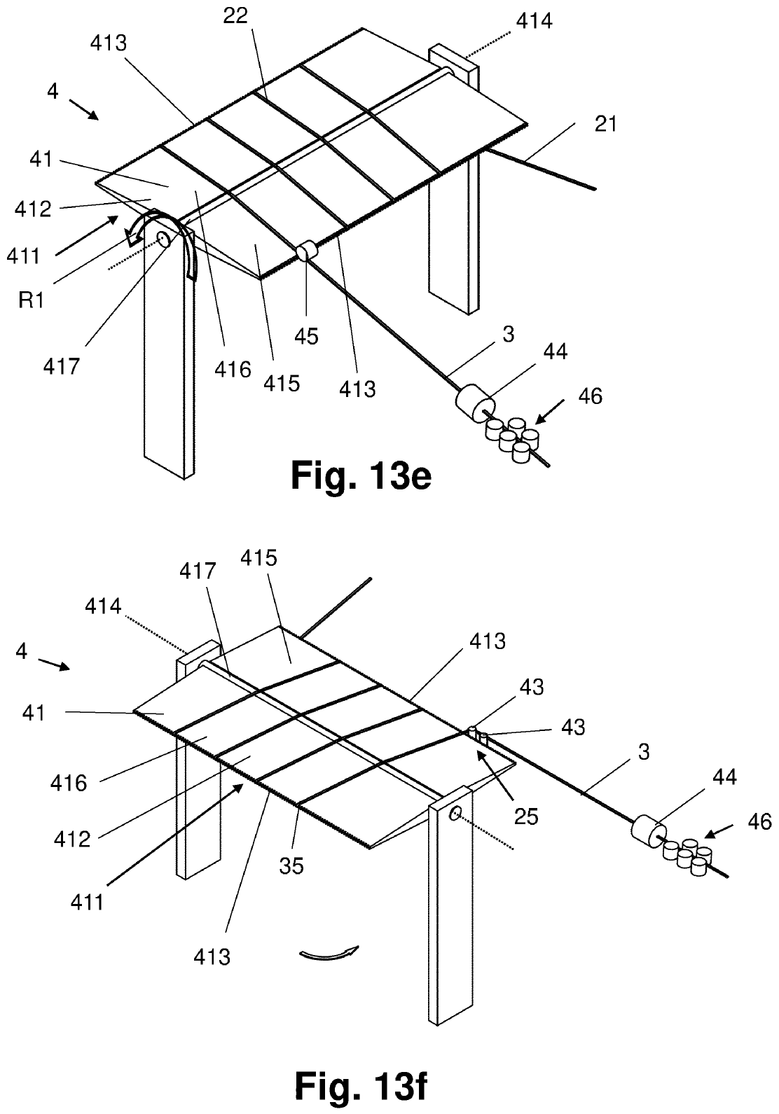

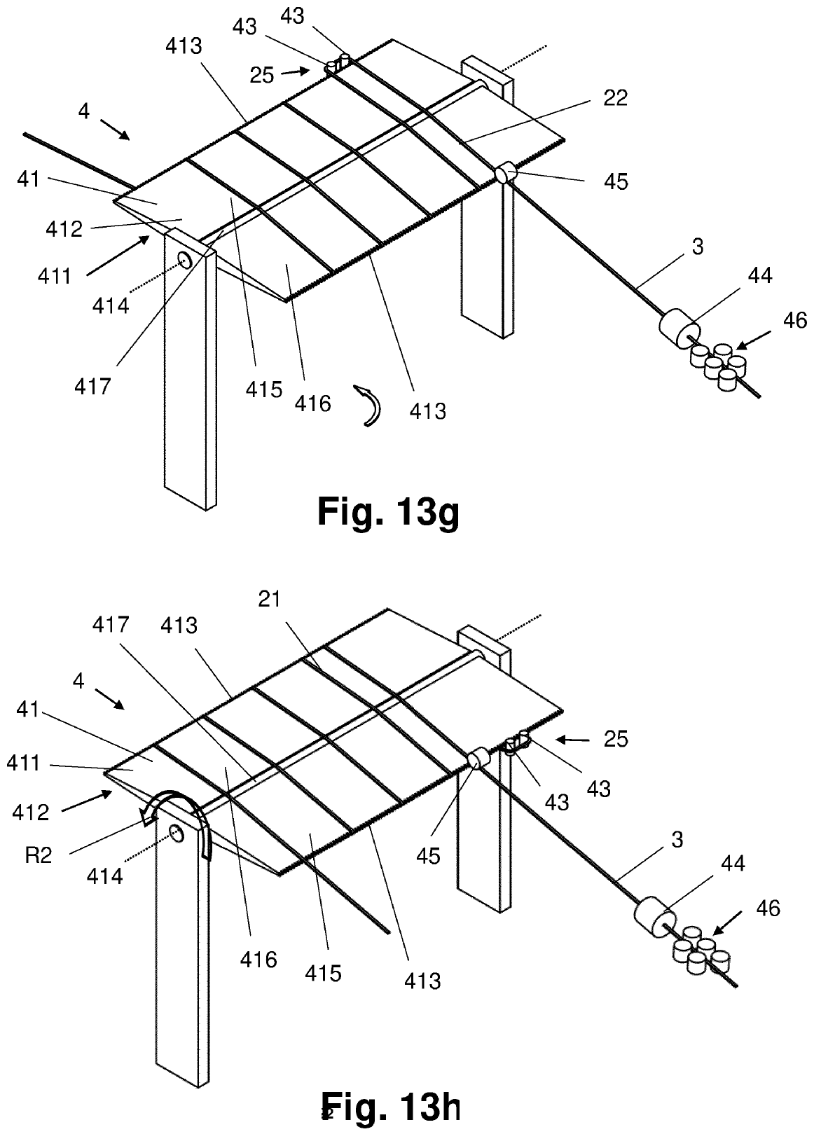

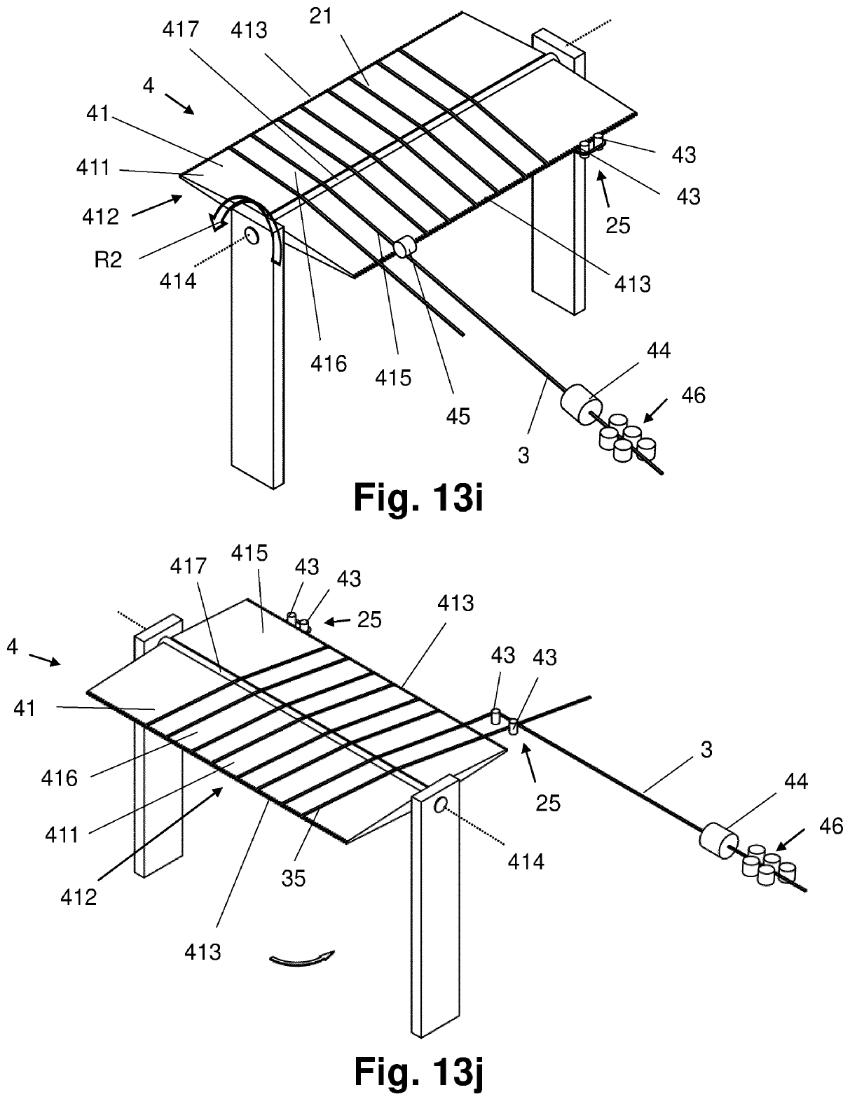

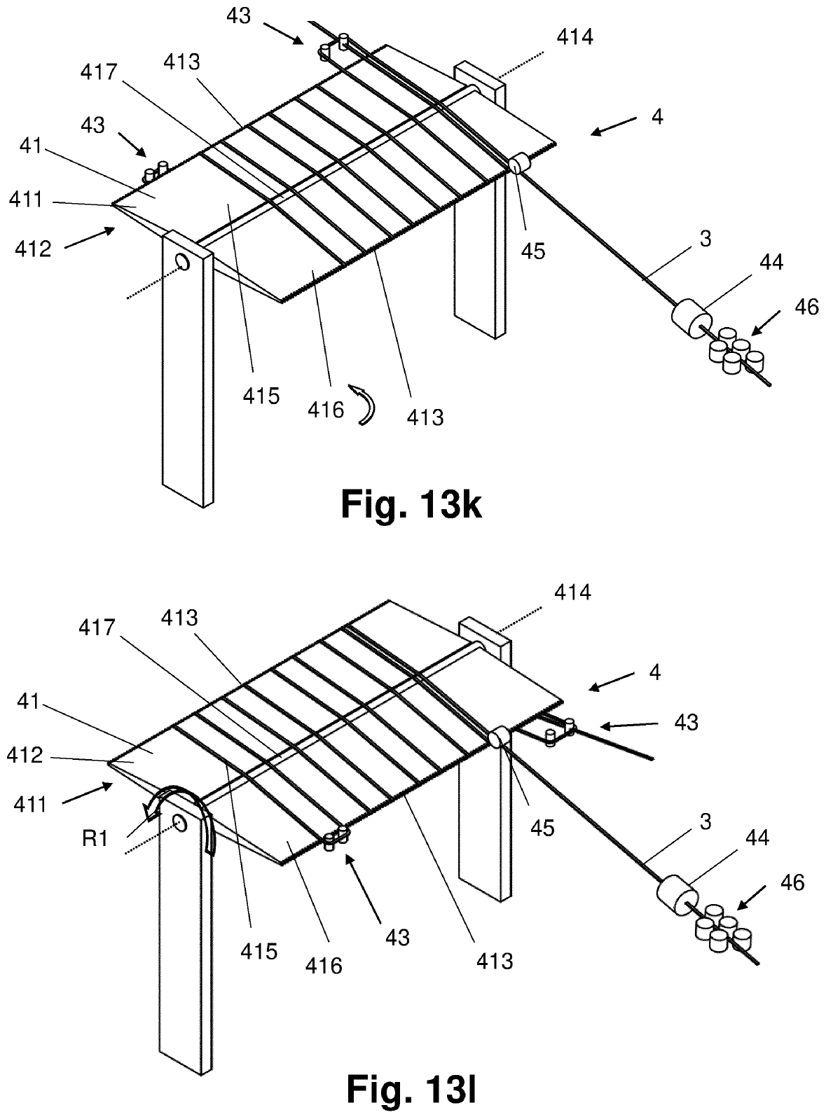

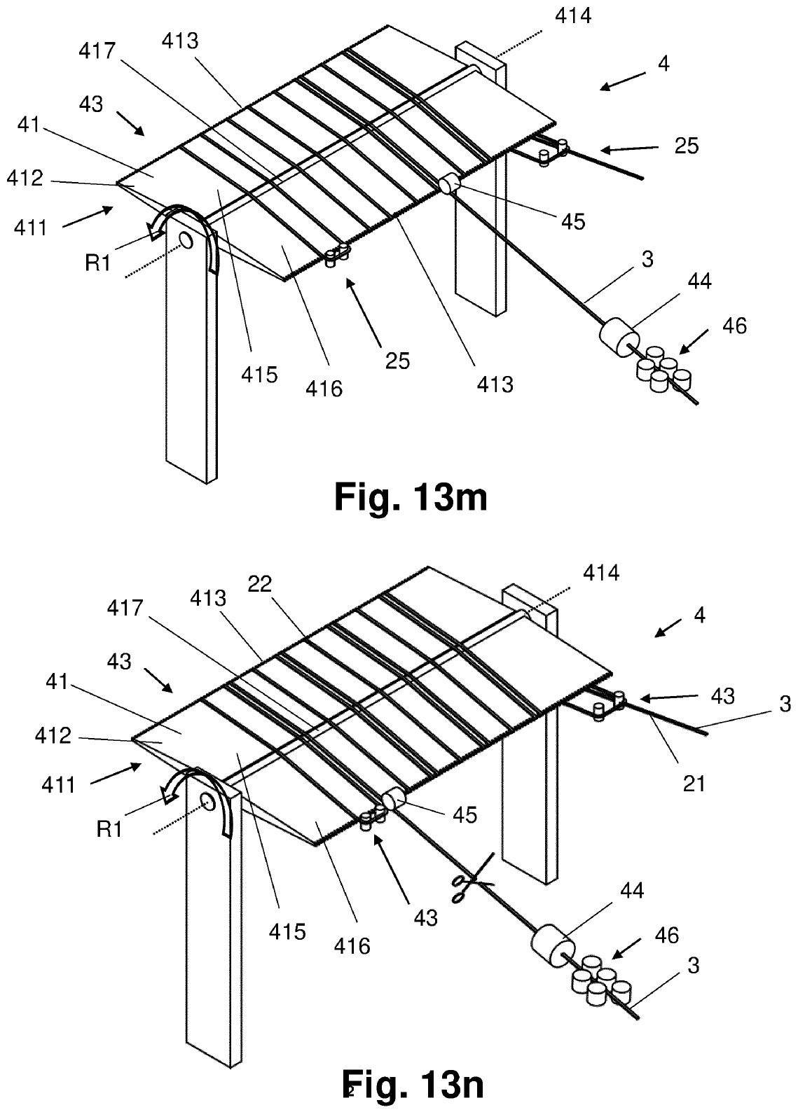

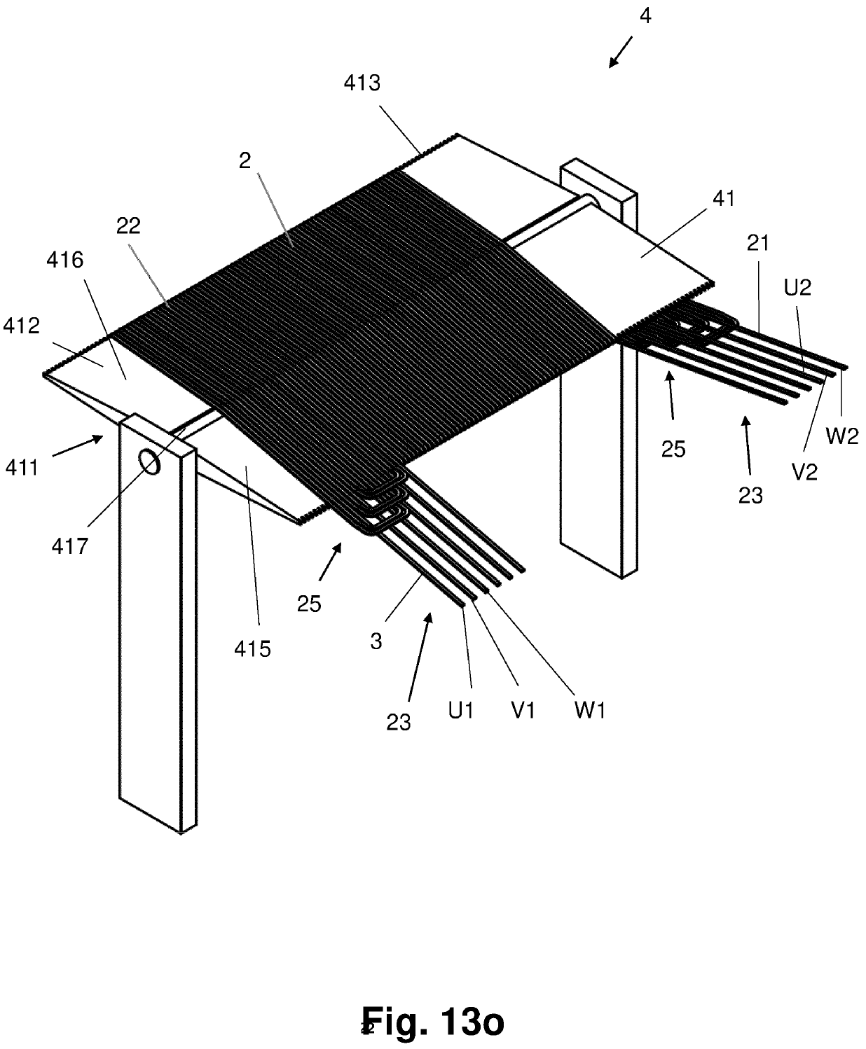

FIGS. 13a to 13o show a series of highly schematic perspective views of a folding apparatus 4 used to manufacture a continuous hairpin winding 2 according to the invention. In particular, FIGS. 13a to 13e relate to an embodiment of the method used for manufacturing a continuous hairpin winding 2 in which each phase winding U1, V1, W1, U2, V2, W2 is comprised of one or more wires 3 which have a single turn, i.e. which are folded over to obtain a flattened quasi-helical ribbon in a single sequence of folding steps in a single folding direction R1. FIGS. 13f to 13o in particular relate to an embodiment of the method used to manufacture a continuous hairpin winding 2 in which each phase winding U1, V1, W1, U2, V2, W2 is comprised of a single wire 3 which has multiple turns (in forward and backward direction) as explained below in more detail. For the sake of conciseness, the various parts and components of the folding apparatus 4 will be explained in detail only in those figures where they appear for the first time.

Further, FIGS. 13a to 13n are shown with only a single wire 3 being wound to form the continuous hairpin winding 2 for the sake of clarity. Depending on the embodiment, there may be multiple adjacent wires 3 arranged in a ribbon and there optionally being gaps between adjacent wires 3, such that the plurality of wires 3 of the ribbon are folded over simultaneously. Folding more than one wire simultaneously increases the productivity and efficiency of manufacture, however also increases the complexity of production. The issue of increased complexity is overcome when using the method of manufacture as described herein, in particular when using the folding apparatus as described. As described above, if each wire 3 has only a single turn then all phase windings U1, V1, W1, U2, V2, W2 can be folded simultaneously and the complexity is relatively low. If, however, each wire 3 has multiple turns, for example three turns and a given wire 3 is associated, for example, with the phase winding U1 of the first set of phase windings U1, V1, W1 as well as the phase winding U2 of the second set of phase windings U2, V2, W2, the complexity is relatively higher because of the return-bending as described herein.

FIG. 13a shows the folding apparatus 4 having a folding member 41 which is rotatable around a folding axis 414. The folding member 41 has a first face 411 and a second face 412 substantially opposite to the first face 411. The folding member 41 comprises two substantially flat or wedge-shaped plates 415, 416 in a planar arrangement having a gap 417 in between, together forming a retaining member for the continuous hairpin winding. The folding member 41 has two straight and parallel opposing edges between the first face 411 and the second face 412, which edges are parallel to each other and are also parallel with the folding axis 414. The folding member 41 further has spacing elements 413 arranged on the folding member 41, particularly on or near the edges between the first face 411 and the second face 412. A plurality of wires 3 are arranged in a flat ribbon (only one wire 3 is shown for the sake of clarity) and placed across the folding member 41. The wires 3 of the flat ribbon are straight wires 3 and are arranged with their short cross-sectional sides facing each other. The wires 3 of the flat ribbon are placed across the folding member 41 such that they engage with the spacing elements 413 which are configured to regularly space the wires 3. The flat ribbon is placed across the folding member 41 at an oblique (not equal to 90°) angle with respect to the folding axis 414. The oblique angle can be selected such that a lateral distance (in the direction of the folding axis 414) between a position of the flat ribbon at one edge of the folding member and a position of the flat ribbon at the opposite edge is approximately half of a width of the flat ribbon. This ensures that the flattened helical ribbon obtained during folding has two layers 21, 22 with regularly spaced wires 3. The wires 3 fed from a coil, spool, or reel are unbent using straightening members 46 and then are guided into position and held in position by wire guide members 44. The wire 3 is fed through the straightening members 46 with a pre-determined and consistent back-tension. The straightening members 46 are, for example, rollers in one or two planes. The wire guide members ensure that each wire 3 of the ribbon is correctly oriented and positioned and also ensures a pre-determined level of tension in the wires 3. The folding apparatus 4 further optionally includes one or more wire folding members 45 which hold the ribbon of wires 3 in place during folding. The folding members 45 are arranged in an area of the spacing elements 413, in particular the folding members 45 are in contact with the spacing elements 413 thereby holding the wires 3 in place. The folding members 45, which can be embodied as rollers which roll against the wires 3, ensure that the wires 3 remain adjacent to the folding member 41 during folding. The ribbon of wires 3 is arranged across the first face 411 of the folding member and as such the first layer 21 of the flattened helical ribbon which is to be formed is adjacent to the first face 411.

FIG. 13b shows the folding apparatus 4 during folding of a folded segment 35 which is formed as the rotating member 41 which can rotate about the folding axis 414 in a first direction R1 of rotation. The wire folding member 45 holds the ribbon of wires 3 in place during folding. The guide members 44 ensure that the wire is tensioned appropriately to ensure the folded segment 35 to be formed properly. Because the ribbon of wires 3 between the guide members 44 and the folding member 41 are unbent, i.e. straight, the wire 3 can be under a high level of tension and therefore the rotating member 41 can rotate quickly while still forming the folded segments 35 properly, in particular with a specified turning radius.

FIG. 13c shows the folding apparatus 4 after the first folded segment 35 has been folded. The folding member 41 has rotated through 180° from its initial position. The second layer 22 is adjacent to the second plate 412.

FIG. 13d shows the folding apparatus 4 further along the successive folding over process.

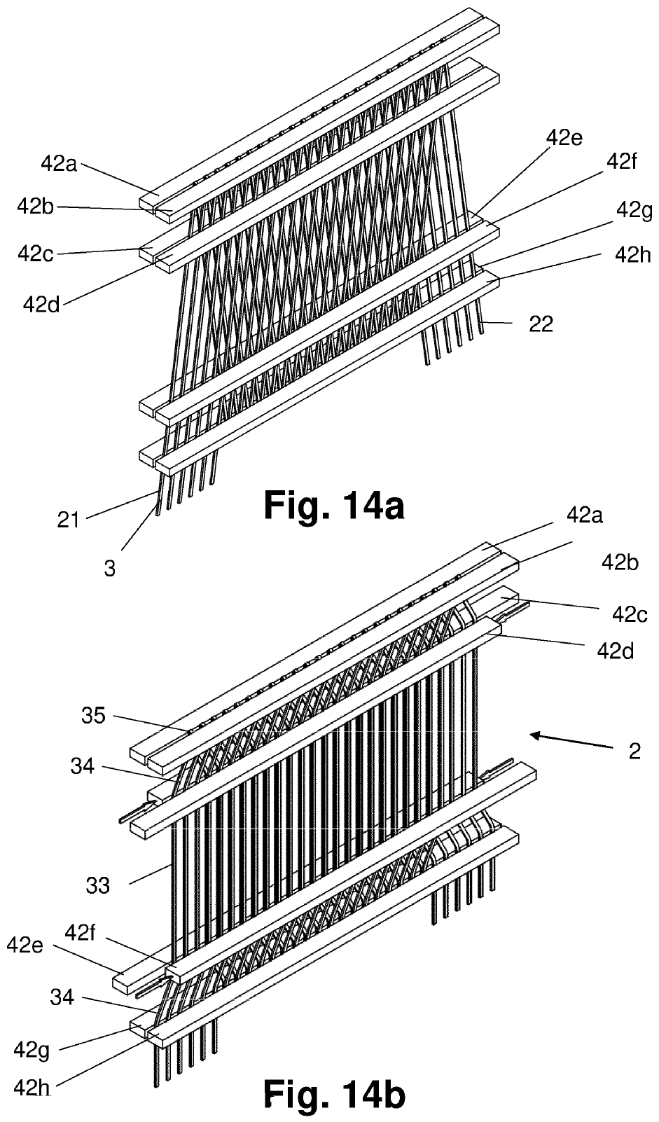

FIG. 13e shows the folding apparatus 4 after the ribbon of wires 3 has been folded into a flattened helical ribbon. In an embodiment, the flattened helical ribbon is removed from the folding apparatus 4 by steps including moving the first plate 415 and the second plate 416 closer together, thereby reducing the gap 417 between the plates 415, 416. The obtained flattened helical spiral has a first layer 21 and a second layer 22 and is ready for having the hairpin shape bent into the wires 3 of the flattened helical spiral as explained below in relation to FIGS. 14a and 14b.

In another embodiment, where each phase winding U1, V1, W1, U2, V2, W2 consists of a single uninterrupted wire 3, obtaining the flattened helical ribbon includes further steps as described below in relation to FIGS. 13f to 13o.

FIG. 13f shows the folding apparatus 4 after being rotated by 90° in a horizontal plane during return-bending of the ribbon. Each wire 3 of the ribbon is bent by 90° around a return bending member 43 in a return bending zone 25. The return bending members 43 are, for example, embodied as pins. In an embodiment, the return bending members 43 extend substantially into a vertical direction orthogonal to a plane of the folding member 41, and each wire 3 of the ribbon is bent simultaneously at a different height position on the return-bending member 43. The return-bending members 43 are positioned such that effectively, the bending zone 25 for each wire 3 occurs at a different distance from the last folded segment 35. This results in the return bends of each wire being non-overlapping when the wires 3 are returned to a horizontal arrangement, ensuring the flattened helical ribbon remains thin.

FIG. 13g shows the folding apparatus 4 after being rotated by a further 90° in the horizontal plane during return-bending of the ribbon. Each wire 3 of the ribbon is bent by a further 90° around a return bending member 43 such that each wire 3 has been return-bent by a total of 180°. The wire 3 after the return bending zone 25 is parallel displaced from the wire 3 before the return bending zone 25. The wire after the return bending zone 25 and the wire 3 before the return bending zone 25 are both associated with the second layer 22 of the flattened helical ribbon.

FIG. 13h shows the folding apparatus 4 during folding of the ribbon of wires 3 after return-bending has taken place. The folding member 41 is rotated about the folding axis 414 in a second direction R2 counter to the first direction R1 to fold the ribbon around the folding member 41 a second time. The wires are guided by the guide members 44 into gaps of the flattened helical ribbon such that the flattened helical ribbon comprises two flat layers 21, 22, the second layer 22 being hidden from view.

FIG. 13i shows the folding apparatus 4 after a second folding sequence has been completed and therefore two turns have been obtained. After the second folding sequence, the wire 3 being guided by the guide members 44 belongs to the same layer 21 as the opposite end of the wire 3.

FIG. 13j shows the folding apparatus 4 after being rotated by 90° in a horizontal plane during a second return-bending of the ribbon. Each wire 3 of the ribbon is bent by 90° around a return bending member 43 in a second return bending zone 25.

FIG. 13k shows the folding apparatus 4 after being rotated by a further 90° in the horizontal plane during the second return-bending of the ribbon. Each wire 3 of the ribbon is bent by a further 90° around a return bending member 43 such that each wire 3 has been return-bent by a total of 180°. The wire 3 after the return bending zone 25 is parallel displaced from the wire 3 before the return bending zone 25. The wire after the return bending zone 25 is and the wire 3 before the return bending zone 25 are both associated with the first layer 21 of the flattened helical ribbon.

FIG. 13l shows the folding apparatus 4 during folding of a third turn of the flattened helical ribbon. The folding member 41 is rotated around the folding axis 414 in the first direction R1, the guide members 44 being configured to guide the wires 3 of the ribbon into remaining gaps of the flattened helical ribbon, in particular guiding the wires 3 into unoccupied spaces of the spacing elements 413.

FIG. 13m shows the folding apparatus 4 further along in a folding sequence for obtaining the third turn of the flattened helical ribbon.

FIG. 13n shows the folding apparatus 4 after the third turn has been obtained. It can be seen that the end of the wire 3 being held by the guide members 44 belongs to the second layer 22 contrary to the other end of the wire 3, which belongs to the first layer 21. In an embodiment the wire 3 is cut. There may be separate wires 3 for the first set of phase windings U1, V1, W1 and the second set of phase windings U2, V2, W2.

In an embodiment the wire 3 is return-bent as described above in a new return-bending zone 25 (see for example FIG. 13m), being separated by a pre-determined distance such that the return-bent wire 3 occupies an appropriate gap for a corresponding wire 3 of the second set of phase windings U2, V2, W2. The folding as described in the steps above is repeated until a similar situation as in FIG. 13n is reached. This return-bending and the continuation of the folding are not shown in a separate figure as the steps are similar to the ones described above. Then the wire 3 is cut. This results in a single uninterrupted wire 3 for the first and the second set of each phase U1, V1, W1.

FIG. 130 shows a completely folded flattened helical ribbon having two sets of phase windings U1, V1, W1, U2, V2, W2, each phase winding U1, V1, W1, U2, V2, W2 consisting of a single wire 3, respectively, having three turns. The wires 3 of the first layer 21 and the second layer 22 are arranged with no gaps. As described above, the flattened helical ribbon is removed from the folding apparatus 4 by steps including moving the first plate 415 and the second plate 416 closer together, thereby reducing the gap 417 between the plates 415, 416.

FIGS. 14a and 14b show the flattened helical ribbon being formed into a flattened quasi-helical ribbon with a hairpin shape resulting in the continuous hairpin winding 2. For reducing clutter in the figures, only a limited number of wires 3 is shown.

FIG. 14a shows a number of wire combs 42 engaged with the wires 3 of the flattened helical ribbon. In particular, four wire combs 42 are used for each layer 21, 22, a pair of wire combs 42 being required for each set of bent segment 34 to be introduced.

FIG. 14b shows the wire combs 42 displaced laterally with respect to each other to introduce the bends for later providing the quasi-helical hairpin shape, thereby forming the continuous hairpin winding 2 with straight segments 33 adjacent to the bent segments 34.

FIG. 14a and FIG. 14b each show eight wire combs 42a, 42b, 42c, 42d, 42e, 42f, 42g, 42h. The wire combs 42c, 42d, 42e, 42f are displaced at an oblique angle with respect to the flattened helical ribbon. Within a first set of four wire combs 42c, 42d; 42e, 42f of the eight wire combs 42a, 42b, 42c, 42d, 42e, 42f, 42g, 42h, wire combs are displaced laterally with respect to each other to introduce the bent segments 34 for forming the quasi-helical shape, thereby forming the continuous hairpin winding 2. As can be seen in FIG. 14b, in particular indicated by the four arrows corresponding to the four displaced wire combs 42c, 42d, 42e, 42f, these four wire combs 42c, 42d, 42e, 42f form two movable pairs of wire combs in which the pair members are mutually displaced to introduce the bent segments 34. For example, two wire combs 42d, 42f, which form a pair of wire combs, are laterally displaced against each other (i.e. are moved in opposite lateral directions) to introduce the straight segments 33 and bent segments 34. The two wire combs 42d, 42f are each moved a distance such that the straight segment 33 is perpendicular to an extension of the wire combs 42d, 42f. The other wire combs 42a, 42b, 42g, 42h arranged next to the folded segments 35 are not displaced and hold the wires 3 in a fixed position while the straight segments 33 of the continuous hairpin winding 2 are formed by the lateral movements of the wire combs 42c, 42e; 42d, 42f in between. Each of the wire combs 42c, 42d, 42e, 42f engages with one side of the flattened helical ribbon and moves parts of the side of the flattened helical ribbon by a lateral displacement to create the straight segments 33 creating thereby the flat continuous hairpin winding 2. In other words, one of the pair of wire combs 42d, 42f is displaced in opposite direction parallel to the folding axis 414 (not shown in FIGS. 14a. 14b) of the folding apparatus 4 (not shown in FIGS. 14a. 14b) compared to the other one of the pair of wire combs 42d, 42f for manufacturing the continuous hairpin winding 2. Similarly, on the opposite side of the flattened helical ribbon, one of the pair of wire combs 42c and 42e moves in opposite lateral direction relative to the other pair member 42e, 42c to form the straight segments 33 between the bent segments 34.

FIGS. 14a and 14b further show the entire flattened helical ribbon having two sets of phase windings U1, V1, W1, U2, V2, W2, each phase winding U1, V1, W1, U2, V2, W2 being formed into the flattened quasi-helical ribbon with the hairpin shape by the lateral displacement of the wire combs 42c, 42d, 42e, 42f. In another embodiment, the flattened helical ribbon has only one set of phase windings or more than two phase windings. In this embodiment, it would still be possible to form the flattened quasi-helical ribbon with the hairpin shape by the lateral displacement of the wire combs 42c, 42d, 42e, 42f engaging with the phase windings of this embodiment.

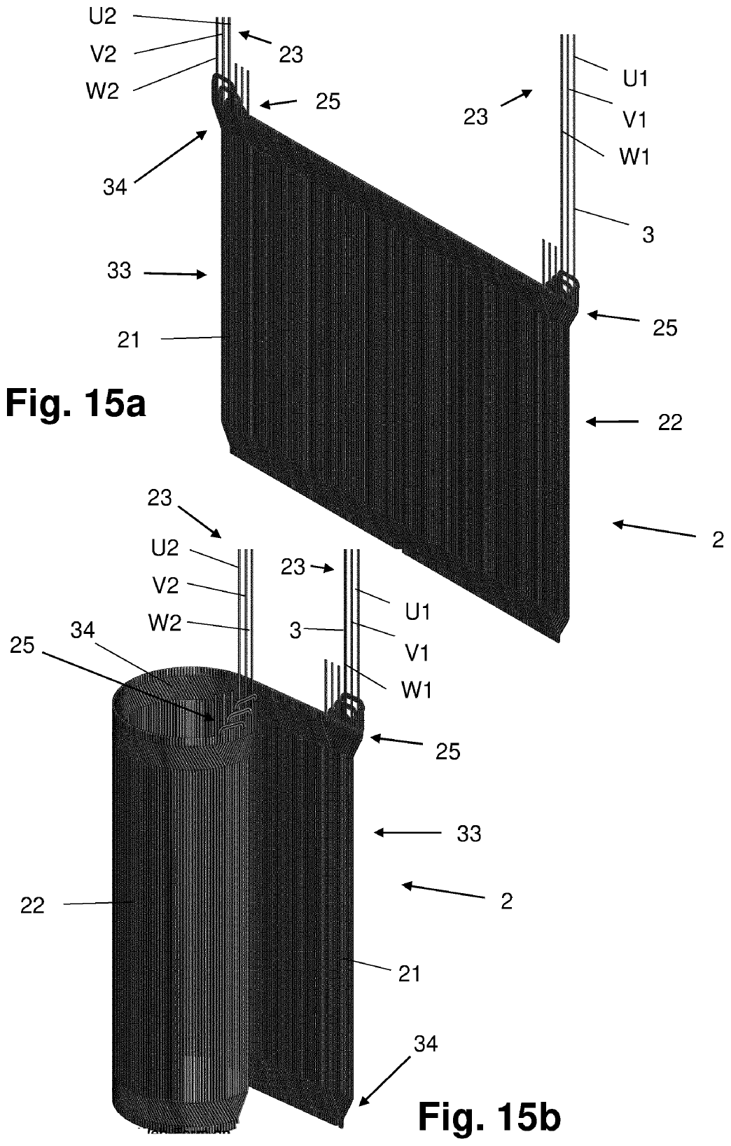

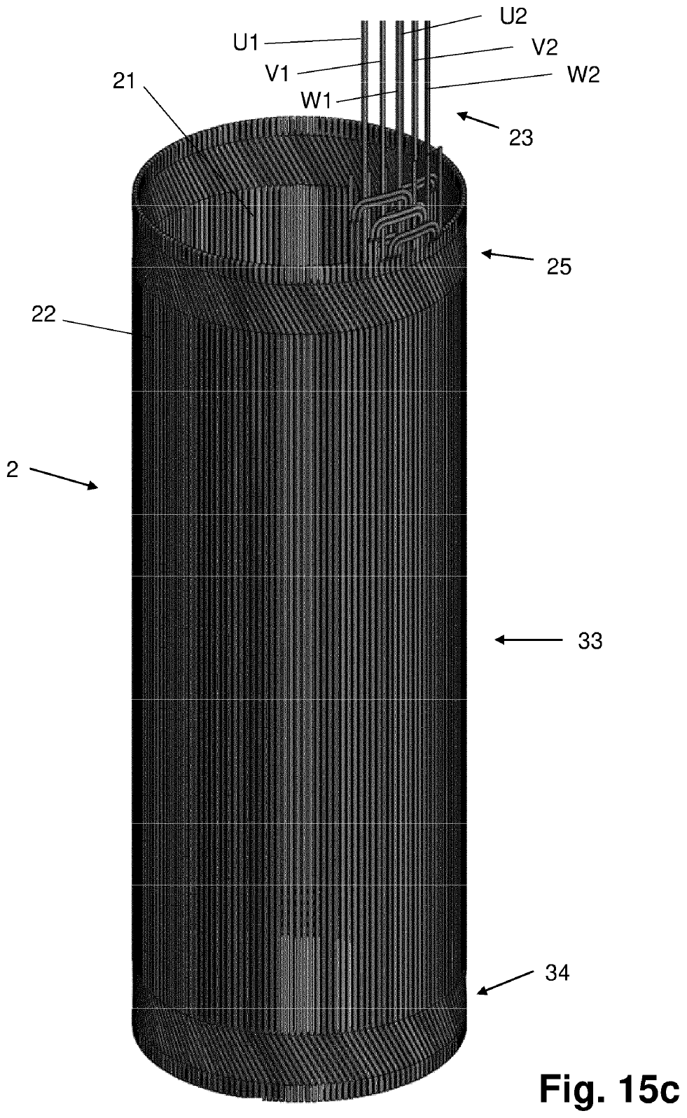

FIGS. 15a to 15c show how the flat continuous hairpin winding 2 is rolled into a ring-cylindrically shaped continuous hairpin winding 2. The flat continuous hairpin winding 2 obtained after the sequence of folding steps described above (and optionally return bending) is shown in FIG. 15a.

FIG. 15a shows the continuous hairpin winding 2 having two layers 21, 22, with the first layer 21 being visible and the second layer 22 on the back-side of the continuous hairpin winding 2 (only partly visible FIG. 15a). On a first lateral edge of the continuous hairpin winding 2, on the side of the continuous hairpin winding 2 of the first set of phase windings U1, V1, W1, the second layer 22 extends beyond the first layer 21. On the opposite lateral edge on the other side of the continuous hairpin winding 2, the first layer 21 extends beyond the second layer 22. These two areas of extensions will overlap each other when the continuous hairpin winding 2 is rolled into a cylindrical shape, as is shown in FIGS. 15b and 15c.

FIG. 15b shows the continuous hairpin winding 2 partially rolled and shows how the two areas of extension described above are complementary in shape and will overlap each other when the continuous hairpin winding 2 is rolled into a cylindrical shape.

FIG. 15c shows the continuous hairpin winding 2 once it has been rolled into a cylindrical shape. As is shown, all the phase windings U1, V1, W1, U2, V2, W2 have input leads 23 on the same side of the continuous hairpin winding 2 and within the same relatively small azimuthal angular range, which is beneficial for electrically connecting the continuous hairpin winding 2, for example to a power source and/or a motor controller. Further, the opposite ends of the wires 3 from the input leads are also in the same area, allowing for a star-ground or a delta connection between the phase windings U1, V1, W1, U2, V2, W2 to be easily formed. Each phase winding U1, V1, W1 of the first set and each corresponding phase winding of the second set U2, V2, W2 have the same phase. They can be wired together in parallel or in series.

The cylindrically shaped continuous hairpin winding 2 is structurally self-supporting. The structural stability can be increased by gluing the layers 21 and 22 in a region of the offset bends. The continuous hairpin winding 2 is easily and quickly inserted into a cylindrical casing 11, in particular without having to deform or bend the continuous hairpin winding 2 in the slightest. This ensures that the continuous hairpin winding 2 maintains its optimal shape with regularly spaced wires 3. Such an optimally shaped continuous hairpin winding 2 is required in particular for the electromechanical apparatus 1 having a very small gap (less than 1 mm) between the continuous hairpin winding 2 and the rotor 13. Having a small gap is obviously advantageous for achieving a higher electromagnetic efficiency and in particular for embodiments where the electromechanical apparatus 1 is ring-cylindrical (with a ring-cylindrical rotor) with a radial thickness that is to be kept as compact as possible.

In an embodiment, the continuous hairpin winding 2 can be potted with a curable potting material to provide further structural support, to further increase the electrical insulation between the wires 3, and to improve heat transport away from the wires 3.

In an embodiment, the continuous hairpin winding 2 is fixed in the casing by being bonded using a bonding material to the casing 11 after insertion.

In an embodiment, the potting of the continuous hairpin winding 2 and the bonding of the continuous hairpin winding 2 to the casing 11 takes place in a single step in which the continuous hairpin winding 2 is inserted into the casing 11 and provided with the curable potting material which further bonds the continuous hairpin winding 2 to the casing 11.

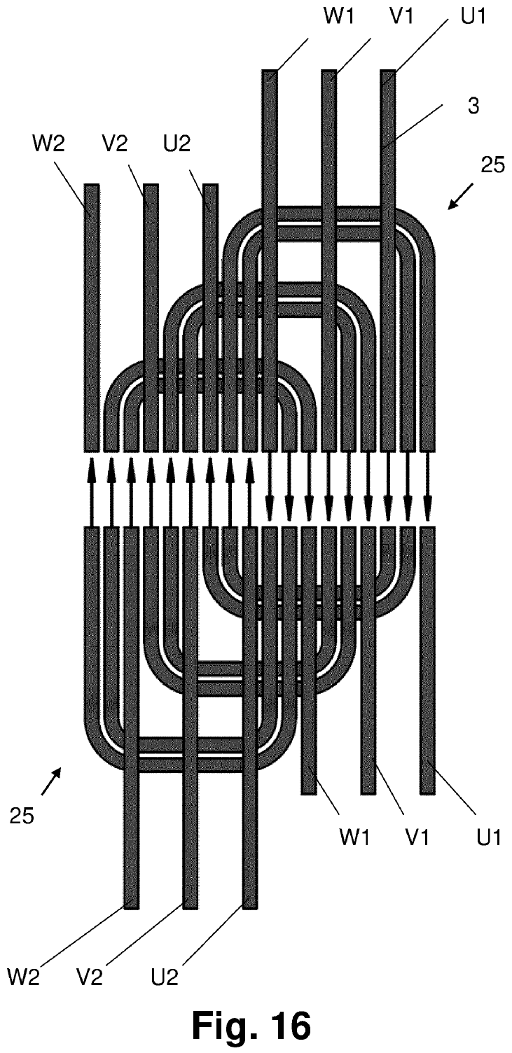

FIG. 16 shows a highly schematic wiring topology of the continuous hairpin winding 2, in particular showing the first and the second return bending zones 25 in an embodiment of the invention in which each phase winding U1, V1, W1, U2, V2, W2 consists of a single uninterrupted wire 3 which has three turns. The entire folded over part of the continuous hairpin winding 2 is omitted and schematically replaced by the arrows which indicate a connection of each wire 3 (only one wire 3 is labelled to avoid clutter). Further, the second set of phase windings U2, V2, W2 are shown below the first set of phase windings U1, V1, W1 purely for illustrative purposes such that the electrical connections between these can be illustrated more clearly. After the wire 3 has completed one turn through the continuous hairpin winding 2, it is return bent and, now being associated with the corresponding phase winding U2 of the second set of phase windings U2, V2, W2, completes a second turn in the continuous hairpin winding 2. It is then return bent a second time and after the second return bending is again associated with the phase winding U1 of the first set of phase windings U1, V1, W1. The wire 3 is arranged adjacent once removed to its original position and completes a third turn in the continuous hairpin winding. In this figure, the return-bent wires are all return-bent in the same direction which provides for simpler manufacture.

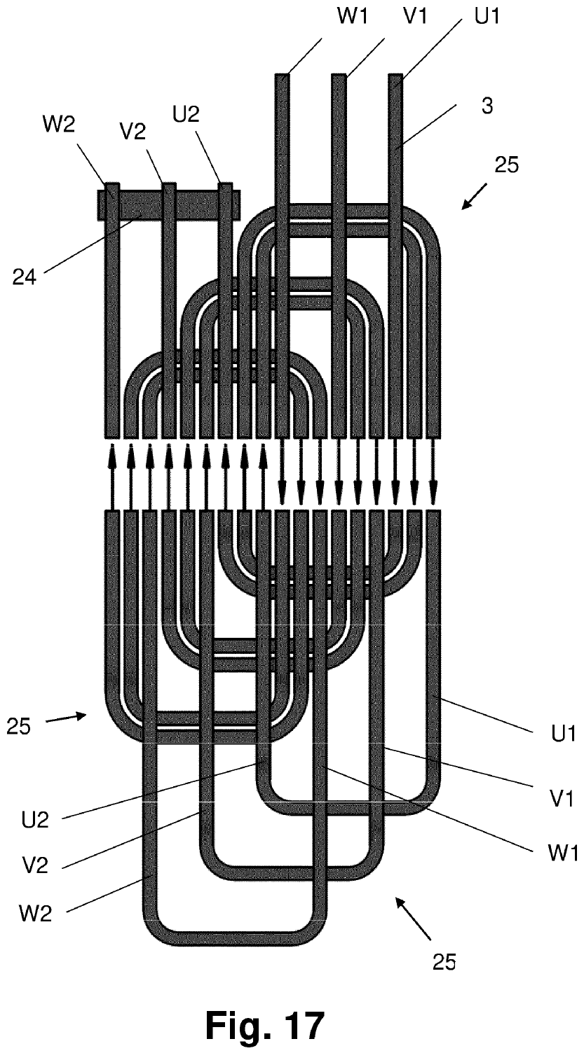

FIG. 17 shows a highly schematic wiring topology of the continuous hairpin winding 2 similar to FIG. 16, but with outlets of the wires 3 of the first set of phase windings U1, V1, W1 being return-bent such that the wires 3 of the first set of phase windings U1, V1, W1 may also serve as the wires 3 of the second set of phase windings U2, V2, W2. Each wire 3 has six turns, three of them as part of the first set of phase windings U1, V1, W1, and three more as part of the second set of phase windings U2, V2, W2. In an embodiment where a single uninterrupted wire 3 forms both a particular phase winding U1, V1, W1 and the same wire 3 also forms the corresponding phase winding U2, V2, W2 of the second set, the wire 3 has an even number of turns. The return-bending takes places in an additional return-bending zone 25 similarly to the previous return-bending zones. The wires 3, after forming the second set of phase windings U2, V2, W2, are joined together to form a star ground 24. The advantages of this embodiment are that only three wires 3 are required to form two sets of phase windings U1, V1, W1, U2, V2, W2 and that the only electrical joins required are those for the star ground 24. This reduces the number of electrical joins required to an absolute minimum and therefore is particularly advantageous as forming electrical joins takes additional time, reduces electrical efficiency, and is an error-prone process.

The disclosure comprises embodiments according to the following clauses:

Clause 1: A rotating electromechanical apparatus (1) comprising:
is a casing (11) having a substantially cylindrical inner surface (111) and/or substantially cylindrical outer surface (112);
a ring-cylindrical ironless stator (12) arranged adjacent to the substantially cylindrical inner surface (111) or to the substantially cylindrical outer surface (112) of the casing (11), respectively,
the ring-cylindrical ironless stator (12) including a continuous hairpin winding (2) having at least two layers (21, 22); and
a rotor (13) arranged coaxially with the ironless stator (12).

Clause 2: The rotating electromechanical apparatus (1) of clause 1, wherein the casing (11) has a substantially cylindrical inner surface (111) and the stator (12) is arranged inside the casing (11) adjacent to the inner surface (111) of the casing (11).

Clause 3: The rotating electromechanical apparatus (1) of one of clauses 1 or 2, wherein the continuous hairpin winding (2) consists of one or more substantially rectangular or flattened wires (3) which are insulated, preferably the wires (3) having a ratio of width to height in a range of 1:1-5:1, more preferably 2:1.

Clause 4: The rotating electromechanical apparatus (1) of one of clauses 1 to 3, wherein the continuous hairpin winding (2) comprises a plurality of interlaced phase windings (U1, V1, W1, U2, V2, W2), each phase winding (U1, V1, W1, U2, V2, W2) consisting of one or more adjacent wires (3), preferably comprising one to five adjacent wires (3), more preferably comprising one wire (3).

Clause 5: The rotating electromechanical apparatus (1) of one of clauses 1 to 3, wherein the continuous hairpin winding (2) comprises a plurality of interlaced phase windings (U1, V1, W1, U2, V2, W2), each phase winding (U1, V1, W1, U2, V2, W2) consisting of a single uninterrupted wire (3) having multiple turns around the ring-cylindrical shape of the stator (12), preferably three turns or five turns, in particular wherein the multiple turns are formed by the method of clause 22.

Clause 6: The rotating electromechanical apparatus (1) of one of clause 4 or 5, wherein the continuous hairpin winding (2) has two sets of phase windings (U1, V1, W1, U2, V2, W2), a first set of phase windings (U1, V1, W1) running along the ring-cylindrical shape of the stator (12) in a first direction and a second set of phase windings (U2, V2, W2) running along the ring-cylindrical shape of the stator (12) in a second direction counter to the first direction, both sets having input leads (23) on a same end of the stator (12), when seen in an axial direction (A) of the stator (12), and within an azimuthal angle range (cp) of less than 60 degrees, preferably less than 45 degrees.

Clause 7: The rotating electromechanical apparatus (1) of one of clauses 1 to 6, wherein the substantially cylindrical inner surface (111) and/or the substantially cylindrical outer surface (112) of the casing (11) extends or extend along more than one third, preferably more than one half, more preferably more than two thirds, of the axial extension of the ring-cylindrical ironless stator (12).

Clause 8: The rotating electromechanical apparatus (1) of one of clauses 1 to 7, wherein an outer radius of a folding region (35), in particular folded segment (35), of the wire (3) does neither extend beyond an outer surface of the first layer (21) nor beyond an outer surface of the second layer (22).

Clause 9: The rotating electromechanical apparatus (1) of one of clauses 1 to 8, wherein the rotor (13) is ring-cylindrical such that the rotating electromechanical apparatus (1) has an empty inner cylindrical region.

Clause 10: The rotating electromechanical apparatus (1) of clause 9, further comprising an additional stator inside the rotor (13), the additional stator having an additional continuous hairpin winding, in particular being a continuous hairpin winding (2) according to one of the preceding clauses.

Clause 11: The rotating electromechanical apparatus (1) of one of clauses 1 to 10, wherein the continuous hairpin winding (2) is encapsulated and/or fixed to the casing (11) by a curable potting material.

Clause 12: The rotating electromechanical apparatus (1) of one of clauses 1 to 11, wherein the casing (11) comprises a strip of laminated magnetically permeable material, preferably an iron-alloy, wound helically to form a ring-cylindrical casing (11).

Clause 13: The rotating electromechanical apparatus (1) is an electric motor, in particular radial flux motor.

Clause 14: The rotating electromechanical apparatus (1) is an electric generator, in particular radial flux generator.

Clause 15: Method for manufacturing a continuous hairpin winding (2) for an ironless stator (12), in particular for manufacturing a continuous hairpin winding (2) for a stator (12) or for an additional stator for a rotating electromechanical apparatus (1) according to one of clauses 1 to 14, the method comprising the steps of:
arranging a plurality of wires (3) straight side by side in a ribbon;
folding-over the ribbon of the plurality of wires (3) in a first direction of rotation (R1) successively along successive fold lines (F) present along a longitudinal axis of the ribbon, the fold lines (F) being at an oblique angle with respect to the longitudinal axis such that the successively folded-over ribbon forms a flattened helical ribbon providing a first layer (21) and a second layer (22);
bending, into each wire (3) of the flattened helical ribbon a straight segment (33) between each successive fold line (F) such that the straight segments (33) run substantially perpendicular to the fold lines (F) of the flattened helical ribbon such that a quasi-helical ribbon is formed; and
rolling the flattened quasi-helical ribbon into a cylindrical shape to form a ring-cylindrical continuous hairpin winding (2), with the straight segments (33) running substantially parallel to a cylinder axis of the cylindrical shape.

Clause 16: The method of clause 15, wherein an outer radius of a folded segment (35) of the wire (3) does neither extend beyond an outer surface of the first layer (21) nor beyond an outer surface of the second layer (22).

Clause 17: The method of one of clauses 15 to 16, wherein the wires (3) are rectangular or flattened wires (3) which are insulated, preferably the wires (3) having a ratio of width to height in a range of 1:1-5:1, more preferably 2:1.

Clause 18: The method of one of clauses 15 to 17, wherein the wires (3) are comprised of a plurality of round conductors (31), in particular litz wires (31), each wrapped in a conductor insulator to form a conductor package (3a), in particular the conductor package (3a) being wrapped in an outer insulator (32).

Clause 19: The method of clause 18, wherein the plurality of round conductors (31) are arranged relative to one another in a flat shape, in particular parallelogram-like shape, thereby forming the rectangular or flattened wire (3).

Clause 20: The method of one of clauses 15 to 19, further comprising potting the continuous hairpin winding (2) using a curable potting material.

Clause 21: The method of one of clauses 15 to 20, further comprising inserting the continuous hairpin winding (2) into a casing (11) having a substantially cylindrical inner surface (111), or fitting the continuous hairpin winding (2) onto the casing (11) having a substantially cylindrical outer surface (112) or onto a support of the apparatus (1), for mounting the continuous hairpin winding (2) in the rotating electromechanical apparatus (1).

Clause 22: The method of one of clauses 15 to 21, wherein the continuous hairpin winding (2) comprises a plurality of interlaced phase windings (U1, V1, W1, U2, V2, W2), each consisting of a single uninterrupted wire (3) having multiple turns around the ring-cylindrical shape of the stator (12), preferably three turns or five turns, wherein multiple turns are formed by:
arranging the plurality of wires, one wire (3) for each phase winding (U1, V1, W1, U2, V2, W2), straight side by side in the ribbon leaving gaps between the wires (3);
folding-over the ribbon of the plurality of wires in the first direction of rotation (R1) successively along successive fold lines (F) present along a longitudinal axis of the ribbon to form the flattened helical ribbon, the flattened helical ribbon having gaps; and
return-bending the plurality of wires by bending the plurality of wires (3) by a total of 180 degrees in a return-bending zone (25);
folding-over the plurality of wires (3) around the flattened helical ribbon in a second direction of rotation (R2, R1) counter to the last direction of rotation (R1, R2) such that the plurality of wires (3) is folded-over into the gaps of the flattened helical ribbon; and
repeating the steps of return-bending and folding-over until a desired number of turns are obtained.

Clause 23: The method of clause 22, wherein the continuous hairpin winding (2) has two sets of phase windings (U1, V1, W1, U2, V2, W2) and wherein a particular single wire (3) of a particular phase winding (U1, V1, W1, U2, V2, W2) is associated with a first set of phase windings (U1, V1, W1, U2, V2, W2) before the return-bending and associated with a second set of phase windings (U1, V1, W1, U2, V2, W2) after the return-bending, or vice versa.

Clause 24: The method of one of clauses 22 to 23, wherein the return-bending zone (25) comprises one or more bending axes perpendicular to a plane of the flattened—helical ribbon, in particular along a z-direction, and the return-bending the wires (3) comprises bending each single wire (3) about the one or more bending axes.

Clause 25: The method of one of clauses 15 to 24, wherein for a particular wire (3) a first straight segment (33) of the wire (3) immediately before the return-bending zone and a second straight segment (33) of the wire (3) immediately after the return-bending zone both belong to either the first layer (21) or the second layer (22).

Clause 26: The method of one of clauses 15 to 25, wherein the bending comprises bending, into each of the plurality of wires (3), two offset bends, thereby providing the straight segments (33), which are present between the offset bends, parallel and displaced to one another, thereby forming the quasi-helical shape of the ribbon after bending.

Clause 27: Method according to one of clauses 15 to 26, wherein after the rolling the continuous hairpin stator winding (2) forms an overlap area, in which the first layer (21) formerly at a first end of the flattened helical ribbon overlaps with the second layer (22) formerly at a second end of the flattened helical ribbon.

Clause 28: Method for manufacturing a continuous hairpin winding (2) using a folding apparatus (4), in particular the method for manufacturing according to one of clauses 15 to 27, the folding apparatus (4) comprising a folding member (41), wherein:
the folding member (41) has a first face (411) and a second face (412), spacing elements (413), and a folding axis (414) about which the folding member (41) is rotatable; and
wherein folding-over the ribbon of the plurality of wires (3) comprises:
placing the ribbon of the plurality of wires (3) across the first face (411) of the folding member (41) at an oblique angle with respect to the folding axis (414), the plurality of wires (3) being separated by the spacing elements (413); and
rotating the folding member (41) around the folding axis (414), such that the ribbon repeatedly wraps successively around the first face (411) and the second face (412) of the folding member (41), thereby forming the flattened helical ribbon.

Clause 29: The method for manufacturing the continuous hairpin winding (2) according to clause 28, wherein the folding apparatus (4) further comprises one or more wire combs (42), and bending the straight segment (33) into each wire (3) of the flattened helical ribbon and thereby forming a quasi-helical ribbon comprises:
engaging the one or more wire combs (42) with the wires (3) of the flattened helical ribbon, in particular with a plurality of or all wires (3) of the flattened helical ribbon simultaneously; and
displacing the one or more wire combs (42) laterally with respect to the lengths of the wires (3) to bend into each wire (3) the offset bends and there-between the straight segments (33).

Clause 30: The method for manufacturing the continuous hairpin winding (2) according to clause 29, wherein at least one of the wire combs (42c, 42d) is linearly displaced in opposite direction parallel to the folding axis (414) of the folding apparatus (4) with respect to another one of the wire combs (42e, 42f) for manufacturing the continuous hairpin winding (2).

Clause 31: The method for manufacturing the continuous hairpin winding (2) according to one of clauses 28 to 30, wherein the folding member (41) comprises a retaining member (415, 416, 417), onto which the flattened helical ribbon is folded-over, which is formed by two flat plates (415, 416) arranged in a plane and next to each other and separated by a gap (417), and manufacturing the continuous hairpin winding (2) further comprises removing the retaining member (415, 416, 417) from the flattened helical ribbon by
moving the flat plates (415, 416) together to reduce the gap (417); and
withdrawing the flat plates (415, 416) from the folded-over flattened quasi-helical ribbon.

Clause 32: Method according to one of clauses 28 to 31, wherein the folding apparatus (4) comprises one or more return-bending members (43), in particular extended along the z-direction, and return-bending the wires (3) comprises rotating the folding apparatus (4) about the one or more return-bending members (43), in particular in a first plane of the flattened helical ribbon, which first plane is parallel to the first and second layer (21, 22) before the step of rolling.

Clause 33: Method according to clause 32, wherein the return-bending the single wires (3) comprises return-bending the wires (3) of a given set about a same return-bending member, each wire (3) of the given set being bent at a different height position on the same return-bending member (43).

Clause 34: Method according to clause 33, wherein the return-bending the wires (3) comprises positioning the return-bending members (43) such that after complete return-bending, in particular by a total of 180°, each of the wires (3) does not overlap any other wire (3) in a plane orthogonal to the z-direction.

Clause 35: Folding apparatus (4) for manufacturing a continuous hairpin winding (2) comprising a folding member (41) rotatable about a folding axis (414) having a first face (411), a second face (412), and spacing elements (413) configured to receive wires (3) and space them.

Clause 36: The folding apparatus (4) of clause 35, further comprising one or more wire combs (42) configured to engage with the wires (3), wherein the wire combs (42) are displaceable along the folding member (41) in a direction parallel to the folding axis (414) of the folding apparatus (4).

Clause 37: The folding apparatus (4) of clause 36, wherein at least one of the wire combs (42c, 42e) is linearly displaced in opposite direction parallel to the folding axis (414) of the folding apparatus (4) with respect to another one of the wire combs (42d, 42f) for manufacturing the continuous hairpin winding (2).

### LIST OF REFERENCE NUMERALS

rotating electromechanical apparatus, electric motor, electric generator 1
casing 11
inner surface (of casing) 111
outer surface (of casing) 112
ring-cylindrical ironless stator 12
rotor 13
rotor poles 131
shell 14
stator-rotor gap 15
continuous hairpin winding 2
first layer (of continuous hairpin winding) 21
second layer (continuous hairpin winding) 22
input leads 23
star ground 24
return bending zone 25
ground G
fold line F
displacement distance D
wire(s) 3
conductor package 3a
wire conductor, round conductor, litz wire 31
wire insulator 32
straight segment 33
bent segment, offset bend 34
folded segment 35
folding apparatus 4
folding member 41
first face of folding member 411
second face of folding member 412
spacing elements 413
folding axis 414
first flat plate 415
second flat plate 416
gap (between first and second plates) 417
wire combs 42, 42a, 42b, 42c, 42d, 42e, 42f, 42g, 42h
return bending member(s) 43
wire guide member(s) 44
wire folding member(s) 45
wire straightening members 46
first direction (of rotation or folding) R1
second direction (of rotation or folding) R2

1. A rotating electromechanical apparatus comprising:
a casing having a substantially cylindrical inner surface and/or substantially cylindrical outer surface;
a ring-cylindrical ironless stator arranged adjacent to the substantially cylindrical inner surface or to the substantially cylindrical outer surface of the casing, respectively,
the ring-cylindrical ironless stator including a continuous hairpin winding having at least two layers; and
a rotor arranged coaxially with the ironless stator.

2. (canceled)

3. The rotating electromechanical apparatus of claim 1, wherein the continuous hairpin winding consists of one or more substantially rectangular or flattened wires which are insulated, preferably the wires having a ratio of width to height in a range of 1:1-5:1, more preferably 2:1.

4. The rotating electromechanical apparatus of claim 1, wherein the continuous hairpin winding comprises a plurality of interlaced phase windings, each phase winding consisting of one or more adjacent wires, preferably comprising one to five adjacent wires, more preferably comprising one wire; or wherein the continuous hairpin winding comprises a plurality of interlaced phase windings, each phase winding consisting of a single uninterrupted wire having multiple turns around the ring-cylindrical shape of the stator, preferably three turns or five turns, in particular wherein the multiple turns are formed by the method of claim 18.

5. (canceled)

6. The rotating electromechanical apparatus of claim 3, wherein the continuous hairpin winding has two sets of phase windings, a first set of phase windings running along the ring-cylindrical shape of the stator in a first direction and a second set of phase windings running along the ring-cylindrical shape of the stator in a second direction counter to the first direction, both sets having input leads on a same end of the stator, when seen in an axial direction of the stator, and within an azimuthal angle range of less than 60 degrees, preferably less than 45 degrees.

7. (canceled)

8. The rotating electromechanical apparatus of claim 1, wherein an outer radius of a folding region, in particular a folded segment, of the wire does neither extend beyond an outer surface of the first layer nor beyond an outer surface of the second layer.

9. The rotating electromechanical apparatus of claim 1, wherein the rotor is ring-cylindrical such that the rotating electromechanical apparatus has an empty inner cylindrical region.

10. The rotating electromechanical apparatus of claim 6, further comprising an additional stator inside the rotor, the additional stator having an additional continuous hairpin winding, in particular being a continuous hairpin winding according to claim 1.

11. The rotating electromechanical apparatus of claim 1, wherein the continuous hairpin winding is encapsulated and/or fixed to the casing by a curable potting material.

12. The rotating electromechanical apparatus of claim 1, wherein the casing comprises a strip of laminated magnetically permeable material, preferably an iron-alloy, wound helically to form a ring-cylindrical casing.

13. The rotating electromechanical apparatus of claim 1 is an electric motor, in particular a radial flux motor; and/or an electric generator, in particular a radial flux generator.

14. (canceled)

15. A method for manufacturing a continuous hairpin winding for an ironless stator, in particular for manufacturing a continuous hairpin winding for a stator or for an additional stator for a rotating electromechanical apparatus according to claim 1, the method comprising the steps of:
arranging a plurality of wires straight side by side in a ribbon;
folding-over the ribbon of the plurality of wires in a first direction of rotation successively along successive fold lines present along a longitudinal axis of the ribbon, the fold lines being at an oblique angle with respect to the longitudinal axis such that the successively folded-over ribbon forms a flattened helical ribbon providing a first layer and a second layer;
bending, into each wire of the flattened helical ribbon a straight segment between each successive fold line such that the straight segments run substantially perpendicular to the fold lines of the flattened helical ribbon such that a quasi-helical ribbon is formed; and
rolling the flattened quasi-helical ribbon into a cylindrical shape to form a ring-cylindrical continuous hairpin winding, with the straight segments running substantially parallel to a cylinder axis of the cylindrical shape.

16. The method of claim 15, wherein an outer radius of a folded segment of the wire does neither extend beyond an outer surface of the first layer nor beyond an outer surface of the second layer.

17. The method of claim 15, wherein the wires are rectangular or flattened wires which are insulated, preferably the wires having a ratio of width to height in a range of 1:1-5:1, more preferably 2:1.

18. The method of claim 15, wherein the wires are comprised of a plurality of round conductors, in particular litz wires, each wrapped in a conductor insulator to form a conductor package, in particular the conductor package being wrapped in an outer insulator.

19. The method of claim 18, wherein the plurality of round conductors are arranged relative to one another in a flat shape, in particular parallelogram-like shape, thereby forming the rectangular or flattened wire.

20. The method of claim 15, further comprising potting the continuous hairpin winding using a curable potting material.

21. The method of claim 15, further comprising inserting the continuous hairpin winding into a casing having a substantially cylindrical inner surface, or fitting the continuous hairpin winding onto the casing having a substantially cylindrical outer surface or onto a support of the apparatus, for mounting the continuous hairpin winding in the rotating electromechanical apparatus.

22. The method of claim 15, wherein the continuous hairpin winding comprises a plurality of interlaced phase windings, each consisting of a single uninterrupted wire having multiple turns around the ring-cylindrical shape of the stator, preferably three turns or five turns, wherein multiple turns are formed by:
arranging the plurality of wires, one wire for each phase winding, straight side by side in the ribbon leaving gaps between the wires;
folding-over the ribbon of the plurality of wires in the first direction of rotation successively along successive fold lines present along a longitudinal axis of the ribbon to form the flattened helical ribbon, the flattened helical ribbon having gaps; and
return-bending the plurality of wires by bending the plurality of wires by a total of 180 degrees in a return-bending zone;
folding-over the plurality of wires around the flattened helical ribbon in a second direction of rotation counter to the last direction of rotation such that the plurality of wires is folded-over into the gaps of the flattened helical ribbon; and
repeating the steps of return-bending and folding-over until a desired number of turns are obtained.

23. The method of claim 22, wherein the continuous hairpin winding has two sets of phase windings and wherein a particular single wire of a particular phase winding is associated with a first set of phase windings before the return-bending and associated with a second set of phase after the return-bending, or vice versa.

24. The method of claim 22, wherein the return-bending zone comprises one or more bending axes perpendicular to a plane of the flattened-helical ribbon, in particular along a z-direction, and the return-bending the wires comprises bending each single wire about the one or more bending axes.

25. The method of claim 15, wherein for a particular wire a first straight segment of the wire immediately before the return-bending zone and a second straight segment of the wire immediately after the return-bending zone both belong to either the first layer or the second layer.

26. The method of claim 15, wherein the bending comprises bending, into each of the plurality of wires, two offset bends, thereby providing the straight segments, which are present between the offset bends, parallel and displaced to one another, thereby forming the quasi-helical shape of the ribbon after bending; and/or wherein after the rolling the continuous hairpin stator winding forms an overlap area, in which the first layer formerly at a first end of the flattened helical ribbon overlaps with the second layer formerly at a second end of the flattened helical ribbon.

27. (canceled)

28. A method for manufacturing a continuous hairpin winding using a folding apparatus, in particular the method for manufacturing according to claim 15, the folding apparatus comprising a folding member, wherein:
the folding member has a first face and a second face, spacing elements, and a folding axis about which the folding member is rotatable; and
wherein folding-over the ribbon of the plurality of wires comprises:
placing the ribbon of the plurality of wires across the first face of the folding member at an oblique angle with respect to the folding axis, the plurality of wires being separated by the spacing elements; and
rotating the folding member around the folding axis, such that the ribbon repeatedly wraps successively around the first face and the second face of the folding member, thereby forming the flattened helical ribbon.

29. The method for manufacturing the continuous hairpin winding according to claim 28, wherein the folding apparatus further comprises one or more wire combs, and bending the straight segment into each wire of the flattened helical ribbon and thereby forming a quasi-helical ribbon comprises:
engaging the one or more wire combs with the wires of the flattened helical ribbon, in particular with a plurality of or all wires of the flattened helical ribbon simultaneously; and
displacing the one or more wire combs laterally with respect to the lengths of the wires to bend into each wire the offset bends and there-between the straight segments: in particular wherein at least one of the wire combs is linearly displaced in opposite direction parallel to the folding axis of the folding apparatus with respect to another one of the wire combs for manufacturing the continuous hairpin winding.

30. (canceled)

31. (canceled)

32. The method according to claim 28, wherein the folding apparatus comprises one or more return-bending members, in particular extended along the z-direction, and return-bending the wires comprises rotating the folding apparatus about the one or more return-bending members, in particular in a first plane of the flattened helical ribbon, which first plane is parallel to the first and second layer before the step of rolling.

33. The method according to claim 32, wherein the return-bending the single wires comprises return-bending the wires of a given set about a same return-bending member, each wire of the given set being bent at a different height position on the same return-bending member.

34. The method according to claim 33, wherein the return-bending the wires comprises positioning the return-bending members such that after complete return-bending, in particular by a total of 180°, each of the wires does not overlap any other wire in a plane orthogonal to the z-direction.

35. A folding apparatus for manufacturing a continuous hairpin winding comprising a folding member rotatable about a folding axis having a first face, a second face, and spacing elements configured to receive wires and space them, further comprising one or more wire combs configured to engage with the wires, wherein the wire combs are displaceable along the folding member in a direction parallel to the folding axis of the folding apparatus: in particular wherein at least one of the wire combs is linearly displaced in opposite direction parallel to the folding axis of the folding apparatus with respect to another one of the wire combs for manufacturing the continuous hairpin winding.

36. (canceled)

37. (canceled)
